(19) United States
(12) Patent Application Publication
(10) Pub. No.: US 2025/0383751 A1
(43) Pub. Date: Dec. 18, 2025

(54) AUGMENTATIVE AND ALTERNATIVE COMMUNICATION (AAC) SOLUTIONS

(71) Applicant: Peter John Ansell, Renton, WA (US)

(72) Inventor: Peter John Ansell, Renton, WA (US)

(21) Appl. No.: 18/745,381

(22) Filed: Jun. 17, 2024

(51) Int. Cl. G06F 3/04817; G06F 3/01; G06F 3/0482; G06F 3/04845; G06F 40/166; G06F 40/242

(52) U.S. Cl. CPC G06F 3/04817; G06F 3/013; G06F 3/0482; G06F 3/04845; G06F 40/166; G06F 40/242

(57) ABSTRACT

Method, software, and apparatus for improved Augmentative and Alternative Communication (AAC) solutions. In one aspect, a user interface is provided with a set of suggestions comprising text, phrases, etc., and navigation buttons that enable users to select words and phrases to add to be written and/or spoken in a manner that reduces the number of user inputs. The suggestions are displayed in alphabetical order in rows with navigation buttons adjacent to the rows, with activation of a navigation button resulting in generation of updated suggestions having alphabetical ranges that are bounded by suggestions in associated rows. This approach may be combined with predictive text means to enable users to easily formulate text and/or speech content.

### BACKGROUND INFORMATION

Some people suffer from neurogenic muscular disorders, such as cerebral palsy, traumatic brain injury, spinal cord injury, Muscular Dystrophy, Amyotrophic Lateral Sclerosis (ALS, also known as Lou Gehrig's Disease) and Multiple Sclerosis (MS). Neuromuscular disorders are often systemic in effect, impairing an individual's ability to operate prosthetic devices, such as a wheelchair, and to perform the activities of daily life, such as speaking, walking, and operating household appliances. Speech is frequently affected since the mechanics of producing speech require coordination of many muscle groups—the muscles of the diaphragm which push air over the vocal cords, the muscles of the larynx, jaws, tongue and lips. The inability to use or coordinate these muscle groups may result in impaired speech.

Devices are available that produce speech, control appliances, and facilitate computer access for people having neuromuscular disorders (“NMD operators”). These devices include Augmentative and Alternative Communication (“AAC”) devices, which allow the operator to select words or phrases by spelling the words, by specifying an abbreviation for the phrase or by selecting a sequence of symbols, and then speak the selected words or phrases using an electronic speech synthesizer or the like. A famous example of such a system was used by the late Stephen Hawkings, whose ALS prevented him from speaking.

FIG. 1 shows a typical configuration of an AAC device for someone living with ALS (Steve Gleason 100 here), which includes a computer 102 such as a tablet mounted on an arm 104 or the like in the person's line of sight. An eye tracker 106 is mounted below the tablet that provides signals to enable software running on the computer to understand what part of the screen is being looked at.

Existing solutions to AAC systems fall into two broad categories, with most solutions being a hybrid between the two. First, there are systems that employ an arrangement of buttons on a virtual page that is displayed on a screen. Each button has an associated action.

These actions might include saying a word or phrase, queuing a word or phrase to be spoken later, saying the queued words, editing the queued words, changing to another page of buttons, launching another computer application, etc.

The buttons can be activated by several means:
On a screen incorporating a touch sensor, by physically touching the button.
Using a mouse to point at the button on screen and physically clicking a button on the mouse.
Pressing a physical button associated with the on-screen button.
Using buttons or other means to move a cursor to a desired button and then activating it.
Using a game controller such as the Xbox Adaptive Controller to steer a cursor to the desired button and active it.
Watching a cursor moving from button to button and clicking a button when it passes over the desired button.
Using an eye tracker and holding gaze on the desired button.
Using an eye tracker and looking at the desired button and pressing a physical button

Other variations to indicate which screen button is to be pushed/selected also exist. These include clicking buttons by other means such as twitching a muscle or doing some other detectable action such as those used in BCI (Brain Computer Interface) implementations.

The second manifestation of AACs mimics the way a traditional user interface works, creating a virtual keyboard that allows the user to type text they wish to communicate. These can allow both an AAC interface to be driven and the computer itself.

Using a virtual on-screen keyboard allows great flexibility in creating text but comes with several costs. Developing these keyboards is an issue because different languages require different keyboards. For example, Microsoft defines more than 400 keyboard variants. The effort to enter a single word will be somewhat proportional to the number of letters or symbols in the word plus one for (typically) a terminating space or punctation mark, where longer words need more effort to create.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 shows a user-device configuration illustrating an example of an AAC use case for a person living with ALS;

FIG. 2 is a block diagram illustrating a block-level architecture overview, according to one embodiment;

FIG. 3 is a diagram of a simplified user interface (UI) used to illustrate examples UI state sequences described and illustrated herein.

FIGS. 3a-3o illustrate respective UI states associated with a UI sequence for entering the text, “This is accessible”, according to one embodiment;

FIG. 4 is a table showing a hard-coded list of words ordered by a likelihood of use;

FIG. 5 is a table showing another view of the hard-coded list of FIG. 4 that is sorted alphabetically;

FIG. 6 is a table showing the list of words in FIG. 4 and further indicating whether a given word is included, operates as a bound, or excluded from a list of suggestions in an example user interface, according to one embodiment;

FIG. 7 is a table showing how the words in the table of FIG. 6 are recategorized in connection with selection of “the” in the user interface associated with the table of FIG. 6;

FIG. 8 is a diagram of a user interface in which the middle navigation buttons have been replaced with buttons that enable a user to spell out new words, according to one embodiment;

FIG. 9 is a table showing an exemplary block sequence;

FIG. 10 is a table showing types of blocks supported by the AAC accessible shell, according to one embodiment;

FIG. 11 is a table showing different logic that may be applied to different types of blocks;

FIG. 12 shows a representation of text comprising “Space! Double Space! The End!”, where there are two spaces after “Double Space!”;

FIG. 13 shows a user interface that includes a keypad that may be generated by the inclusion of hard coded data, according to one embodiment;

FIG. 14a shows a UI with an example of an empty tag containing a date being converted into frozen text in response to selection/activation of a “To Frozen” button;

FIG. 14b shows a UI where text correspond to a “Monday” button, a comma button, an “April” button, a “1” button, a comma button, and a “2024” button are converted to an empty tag by selection/activation of a “To Element” button;

FIGS. 15a-15d show a sequence of UI states in connection with selecting previously entered text to lose;

FIGS. 16a-16h illustrate a sequence of UI states associated with an example under which “This be accessible” is corrected to “This is accessible”;

FIG. 17 shows a tree from an English language text suggester that is expecting the opening monologue from the original and next generation Star Trek televisions shows;

FIG. 18 is a diagram illustrating a portion of a UI in which portions of some buttons are only partially shown; In some embodiments, it is possible that a given tree will layout to an arrangement where some buttons are partially or completely outside the target area. In one embodiment the layout system provides a means to indicate this. The example used above might format to the layout shown in FIG. 18;

FIG. 19 shows a high-level overview of an implementation employing eye-tracker hardware and associated software;

FIG. 20 shows an initial configuration of a user interface for an AAC application, according to one embodiment;

FIGS. 21a-21j show a sequence of UI states associated with entry of the text “This is accessible”, according to one embodiment;

FIG. 21k shows an example of a UI state enabling a user to select to verbalize entered text, according to one embodiment;

FIGS. 21l and 21m show a sequence of UI states demonstrating adding buttons in a text entry area to a dictionary;

FIG. 22 shows an initial configuration of a user interface for an AAC application that includes suggestions derived, in part, using one or more hard-coded n-gram dictionaries, according to one embodiment;

FIG. 23a is a diagram illustrating the conventional arrangement of an AAC apparatus under which the screen blocks the vision between a user and a second person the user is communicating with;

FIG. 23b is a diagram illustrating an example of an autocue or head-up display in which the user and the second person are enabled to maintain eye contact;

FIG. 24 shows a typical view a user of an AAC application running on a computer or tablet would have under the conventional configuration of FIG. 23a, where the computer/tablet blocks the view of the person the user is communicating with;

FIG. 25a shows a first 3D view of autocue apparatus including a tablet on which an ACC application is displayed, according to one embodiment;

FIG. 25b shows a second 3D view of the autocue apparatus that shows a virtual image of the ACC user interface displayed on a reflector;

FIG. 25c shows a backside view of the autocue apparatus and further illustrating the reflector is transparent to a person or people on the opposite side of the user of the autocue apparatus;

FIG. 25d shows how a virtual image of the user interface appears from the viewpoint of a user;

FIG. 25e shows an example of a user interface used for an autocue apparatus, according to one embodiment;

FIG. 26 is a schematic diagram of a mobile device configured to implement aspects of the embodiments described and illustrated herein.

FIG. 27 is a schematic diagram illustrating an architecture for a computer platform such as a laptop or notebook computer;

FIG. 28 is a schematic diagram illustrating a distributed environment in which components of an AAC system may be implemented, according to some embodiments; and

FIG. 29 is a graph illustrating implementation of a dwell time threshold;

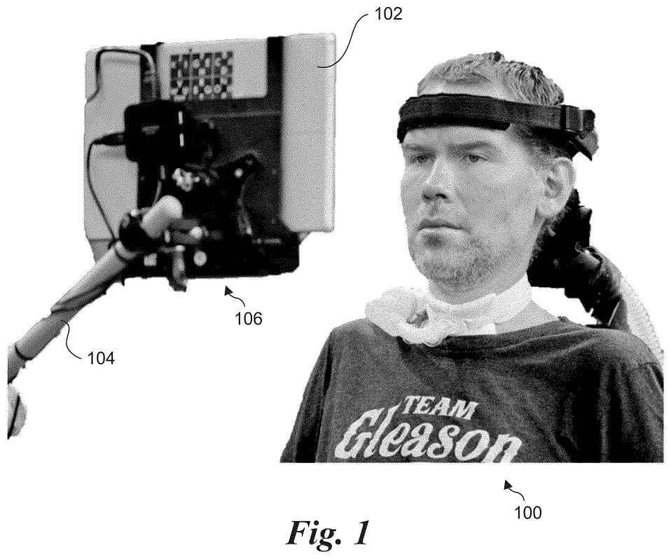

### DETAILED DESCRIPTION

Embodiments of methods, software, and apparatus for improved Augmentative and Alternative Communication (AAC) solutions are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

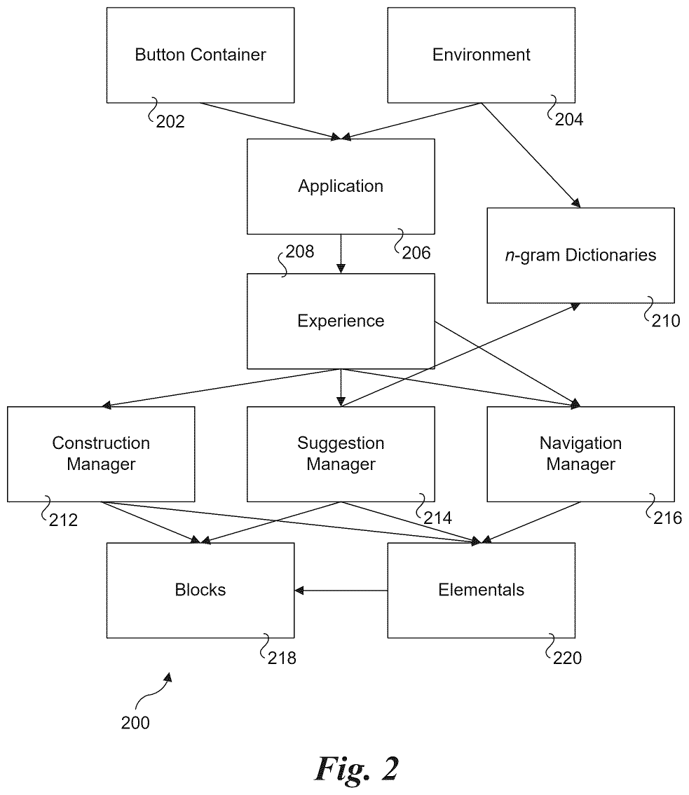

FIG. 2 shows a block-level architecture overview 200 including various modules and components, according to one embodiment. The modules/components include a button container 202, an environment module 204, an application 206, an experience module 208, n-gram dictionaries 210, a construction manager 212, a suggestion manager 214, a navigation manager 216, blocks component 218, and elementals 220.

There are several implementations of the Application, one for each platform being supported. Each implementation creates two platform specific objects, one that supports the user interface and the other that supports everything else.

Button container 202 provides a platform specific way of creating, measuring, and deleting styled buttons. Environment 204 supplies a platform specific way for creating, writing, and reading files, in addition to getting access to a standard speech synthesis interface, access to a clock and a way of reading and writing a clipboard (if it is supported).

The remaining modules may be implemented on multiple platforms and are generally platform independent. Construction manager 212 renders and allows manipulation of created text. It is also responsible for converting text to speech. Suggestion manager 214 creates trees of suggestions and renders them as rows of buttons. The suggestion manager contains versions for suggesting text and actions, the spelling of words and conversion of digits to numerically encoded data such as dollar-values, dates, times, road names, etc. Navigation Manager 216 is tightly coupled to suggestion manager 214 and provides refined context to the suggestion manager when the top ranked suggestions are not what the user wanted.

The n-gram dictionaries 210 are used to drive suggestion manager 214. The n-gram dictionaries provide a means to make hierarchical predictions in their own right, to package up predictions from other sources and to offer up user defined text. An example of packaging up predictions is taking a prediction made by a generative artificial intelligence (AI) implementation employing a Large Language Model (LLM) such as ChatGPT. An example of user defined text may occur when text is lost from the user interface and is added into an n-gram dictionary so that it is made available to be suggested for re-insertion.

Blocks component 218 defines the way text and commands are manipulated and persisted by application 206. A Block corresponds roughly to an XML element. A run of text will normally comprise many Blocks, one per word, punctuation mark and piece of unusual spacing. An XML tag, whether an open, close or empty element will normally be a single Block.

Elementals 220 provide mechanisms to both format Blocks for display or to be spoken and to associate actions with Blocks. When simple text is displayed, one Elemental is normally providing the formatting based on the underlying Blocks, while another Elemental is wrapping this formatting and adding behavior such as adding the text to the Construction Manger if its clicked. Each button in the user interface is associated with an Elemental.

### Accessible Shell

The Accessible Shell is a set of tools for creating computer user interfaces that are accessible to people who have difficulty using a computer through normal means. The set of tools comprises a toolkit including associated tools/libraries/frameworks etc. that may be implemented (or integrated) in an integrated development environment (IDE). Nonlimiting examples of such IDEs include but are not limited to Microsoft® Visual Studio®, Android Studio, Apple® iCode, Eclipse, and Jetbrains Clion. The toolkit may also be integrated in an add-on for an IDE, such as Jetbrains Resharper.

One of the applications of Accessible Shell is to create an AAC application/system useful to people who have both limited means to control a computer and the need for a computer to communicate with them. For example, an exemplary and non-limiting focus of the Accessible Shell is enabling people living with ALS or other NMD operators to access a computer using an eye tracker device as the only means of input. However, parts of the Accessible Shell are universally useful in many situations and may be applied with other means for user input.

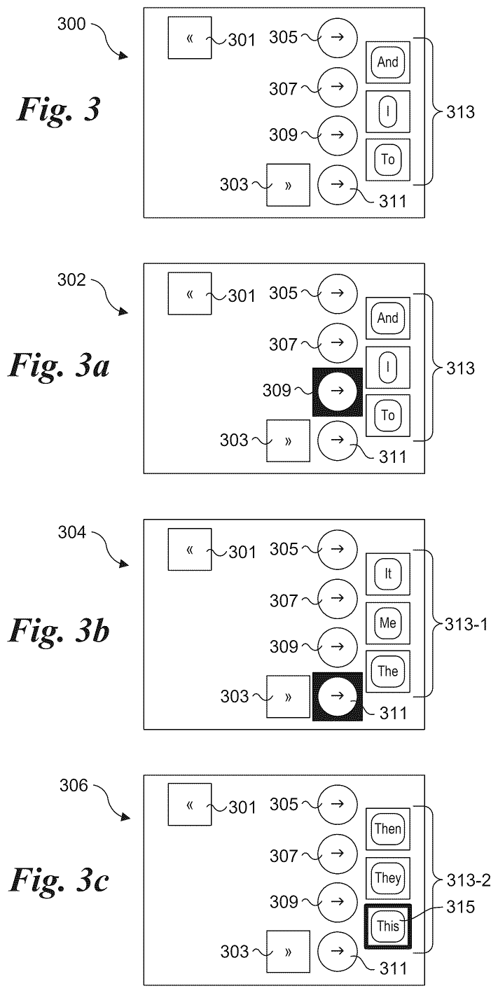

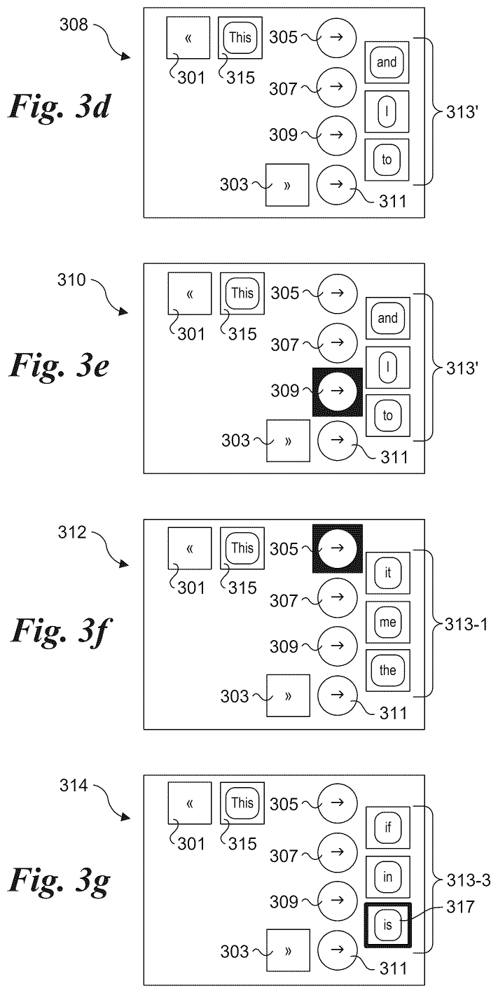

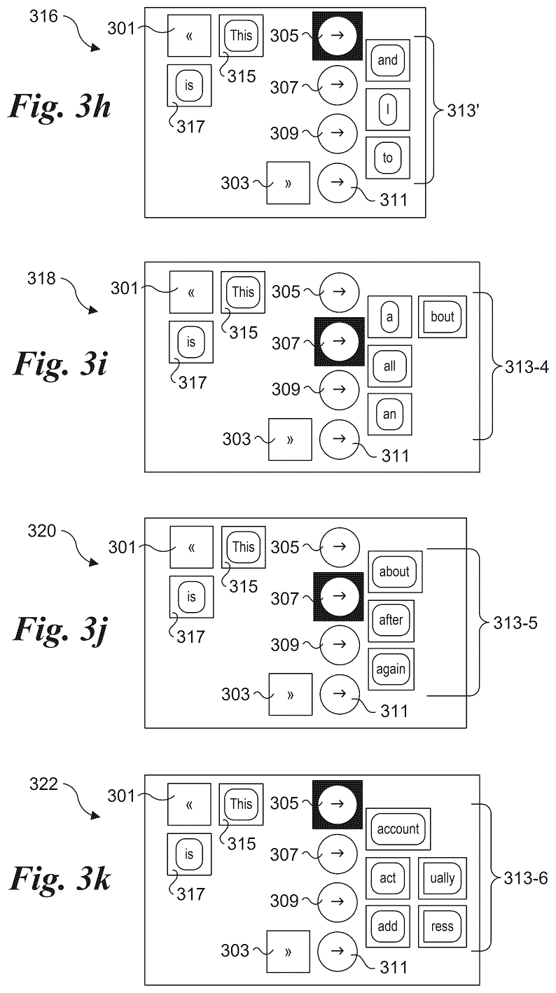

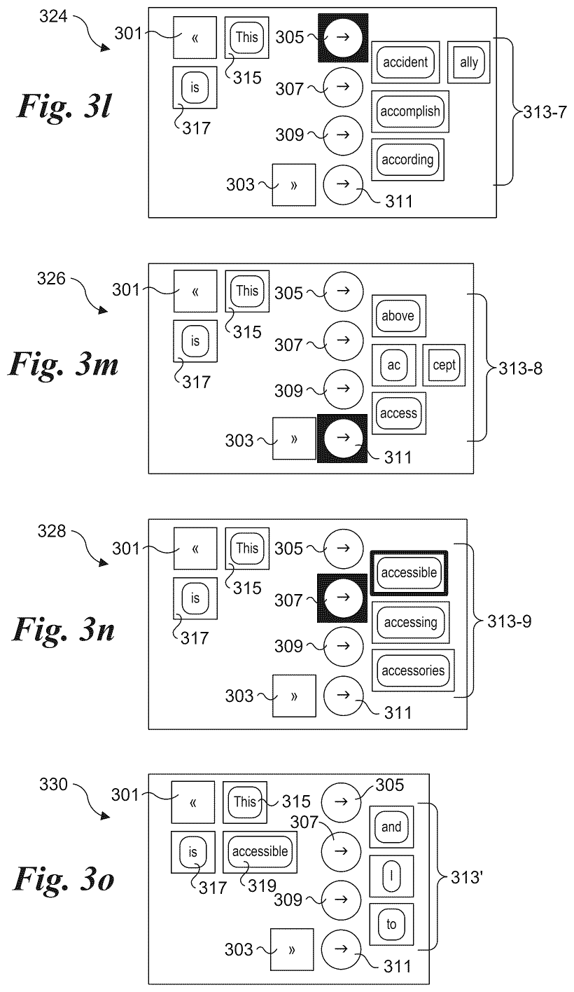

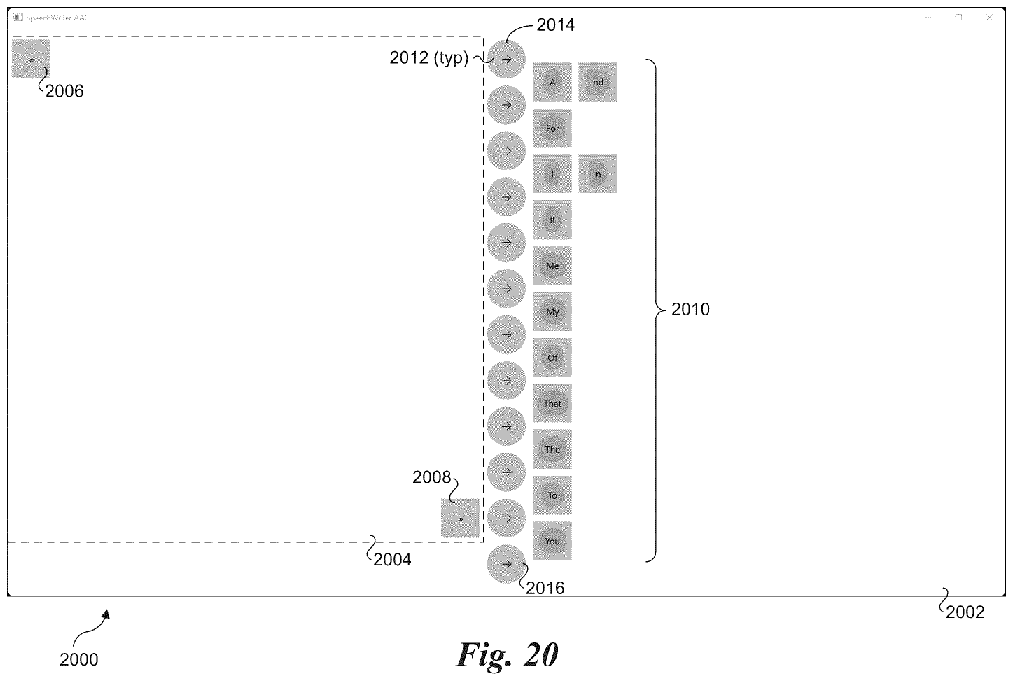

A simplified example of an implementation of the Accessible Shell is shown in FIGS. 3a-3p, which collectively illustrates and interactive user interface (UI) that enables a user to enter the phrase “This is accessible.” While the AAC application would normally be displayed on various sizes of computer screens/displays that would facilitate use of more UI buttons and elements (such as illustrated below in FIGS. 20, 21a-21m, and 22), this example conveys fundamental aspects of the AAC application UI that is scalable to various display/screen sizes.

FIG. 3 shows an example UI interface 300 for an AAC application when it is launched. Each of the items surrounded by a rectangular or circular outline is a button drawn on the screen. The user interface is driven by “pressing” or otherwise selecting or activating the buttons. Pressing/selecting/activating a button can be achieved by many means, but for this example we will assume they are activated by being touched in the manner of buttons on a tablet computer touchscreen. It will be understood by those having skill in the art that other means, such as human-computer interfaces employing eye-tracking, may be used to select or activate the UI buttons.

At a top level, UI interface 300 comprises three areas:
For left-to-right reading languages text is composed into the construction area on the left portion of the screen between a start (Escape or Reset) marker (button) and an end (Send) marker (button). For right-to-left reading language like Arabic and Hebrew the arrangement is reversed.
Suggestions are made on the right portion of the screen, one per row.
Between these two areas is a column of navigation buttons that change the suggestions.

In further detail, UI interface 300 includes an escape (or reset) button 301, an enter (or send) button 303, navigation buttons 305, 307, 309, and 311, and suggestions 313 comprising suggested words and/or phrases. The basic means of operation is to select suggestions 313 from the right hand of the display and transfer them to the left hand of the display. In the embodiments illustrated herein, suggestions 313 are displayed alphabetically. If the target word or phrase among selections 313 is not displayed, pressing the navigation button that points to where the word/phrase would be if it were displayed will cause suggestions 313 to be updated. This process may then be repeated on an ongoing basis to enable a user to enter desired text, textual phrases, and or word/phrases to speak (via text-to-speech synthetization).

As discussed above, the phrase to be entered by the user is “This is accessible.” The initial list of suggestion 313 is “And”, “I”, and “To”. Since “This” is between “I”, and “To,” the user will press navigation button 309, as shown in UI state 302 in FIG. 3a. As shown in UI state 304 of FIG. 3b, this will generate an updated suggestions 313-1 that now includes “It”, “Me”, and “The”. A couple of observations here. Since the user did not select (press buttons for) any of “And”, “I”, and “To”, all these words may be replaced, such is shown here. The (alphabetical) range of the new suggested words and/or phrases will be between the words/phrases above and below the navigation button that is pressed. In other instances, such as illustrated below in FIGS. ______ and ______, the updated suggestions may (optionally) include the existing suggestions as the first or last suggestion or suggestions outside the range when fewer possible suggestions are found within the range.

Since “This” is not among the words/phrases for suggestions 313-1, the user will press navigation button 311 (as highlighted in FIG. 3b), which will generate updated suggestions 313-2 shown in UI state 306 of FIG. 3c comprising “Then”, “They”, and “This.”. In this case, “This” is among the suggested words/phrases in suggestions 313-2, which enables the user to press “This” button 315, as highlighted in FIG. 3c.

As shown in UI state 308 in FIG. 3d, “This” button 315 has been added to the left-hand panel following escape button 301. Suggestions 313-2 are replaced with suggestions 313′, which are the same words as suggestions 313 except now “and” and “to” begin with lowercase letters. The next word to be added is “is,” which is between “I” and “to”; thus, the user presses navigation button 309 as shown in FIG. 3d, which results in generation of updated suggestions 313-1 shown in UI state 312 in FIG. 3f including “it”, “me”, and “the”. Since “is” (alphabetically) is prior to “it”, the user will select navigation button 305, which results in generation of updated suggestions 313-3 that include the words “if”, “in”, and “is” shown in UI state 314 shown in FIG. 3g.

At this point, the user will select “is” button 317, which is added to the left-hand panel following “this” button 315 (in this example below escape button 301), as shown in UI state 316 in FIG. 3h. As further shown, the suggestions are returned to suggestions 313′.

The next word to add is “accessible”, which is before “and”. Thus, the user will activate navigation button 305, as shown in FIG. 3h, which will result in the generation of UI state 318 shown in FIG. 3i. This includes updates suggestions 313-4, including “a”, “bout”, “all”, and “an”. This is an example of suggestions that include split words or phrases in the same row. As illustrated in the examples below for a full UI example, a row may include multiple suggestions, each comprising a word, partial word, or phrase. If the user selects “bout” here (by activating the “bout” suggestion button), the full word “about” will be added to the text entry area.

Since “accessible” is between “a” and “all”, the user will activate navigation button 307, as shown in FIG. 3i. This will result in generation of UI state 320 in FIG. 3i, which includes updated suggestions 313-5 comprising “about”, “after”, and “again.” Note in this example, “about” (a combination of “a” and “bout”) is kept, which is an optional approach according to one embodiment. In other embodiments, the first word/partial word/phrase in the alphabetical order of the updated suggestions will be alphabetically after the last word/partial word/phrase in the row above the navigation button. For example, suggestions 313-5 could include “above” in place of “about.”

Since “accessible” is between “about” and “after” the user will activate navigation button 307, as shown in FIG. 3j. This will result in generation of UI state 322 in FIG. 3k, which includes updated suggestions 313-6 comprising “account”, “act”, “ually”, “add”, and “ress.” As before, selection/activation of “ually” will add “actually” to the text entry area and selection of “ress” will add “address” to the text entry area.

As “accessible” is alphabetically before “account”, the user will activate navigation button 305, as shown in FIG. 3k. This will result in generation of UI state 324 in FIG. 3l, which includes updated suggestions 313-7 comprising “accident”, “ally”, “accomplish”, and “according.” The user will then activate navigation button 305, which will result in generation of UI state 326 in FIG. 3m. Updated suggestions 313-8 include “above”, “ac”, “cept”, and “access”.

Next, the user will then activate navigation button 311, leading to generation of UI state 328 in FIG. 3n having updated suggestions 313-9 including “accessible”, “accessing”, and “accessories.” Now with “accessible” being one of the suggestions, the user will activate the “accessible” button 319, as shown in FIG. 3n. This will add “accessible” button 319 to the text entry area following “is” button 317, as shown in UI state 330 in FIG. 30. In this example, the updated suggestions will return to suggestions 313′.

Notice that both the two words “This” and “is” are fairly common and were entered using three presses respectively. On a larger screen in which the UI is likewise larger, “This” and “is” could have been entered with fewer presses. However, typing “This is” with a trailing space picking between letters on a virtual keyboard would have taken an extra press and been far more likely to result in an input error that would need correction.

The word “accessible” is long and less common than the first two words. Picking out its letters on a virtual keyboard would take ten presses. Under one embodiment of the Accessible Shell solution, it will take seven presses.

### Under the Hood Navigation

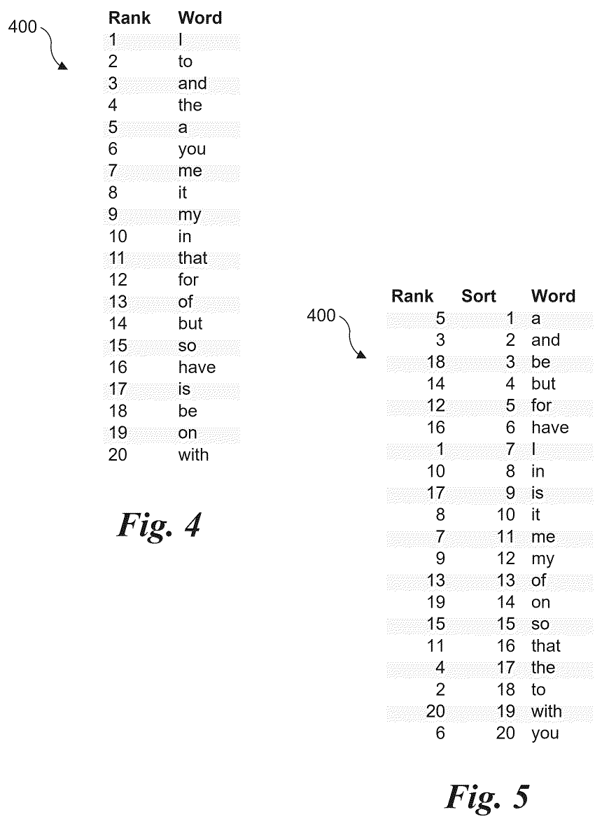

In one embodiment, the suggestions in the foregoing example are generated by the following mechanism. For a given context the system can generate a list of words in descending order of likelihood. The simplest mechanism for doing this is to have a hard coded list. Such a list may look like Table 400 shown in FIG. 4. The list can be sorted alphabetically, such as shown in Table 500 of FIG. 5.

When the first set of suggestions are made the highest ranked words are offered in sorted order. In the preceding user interface example, the highest ranked words are “I”, “to” and “and” which are offered sorted as “and”, “I” and “to”.

Following the example, we click between “I” and “to”. To find the words that we should now offer we split the list into three:
A ranked list of words that sort between the two boundary words, here “I” and “to”.
The boundary words in ranked order, here “I” and “to”.
A ranked list of words that sort outside the two boundary words.

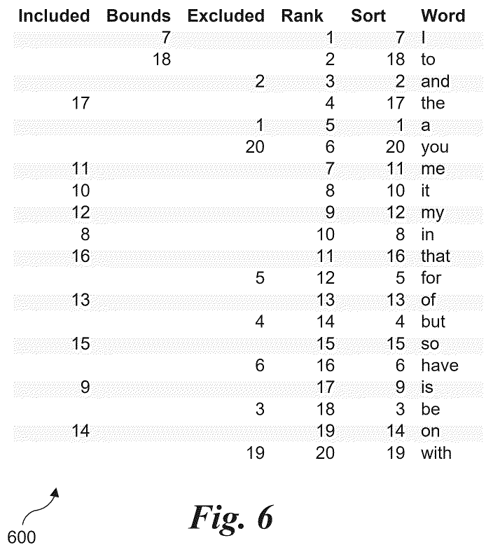

With reference to Table 600 in FIG. 6, the chosen words to suggest are taken from the “Included” column first, then the “Bounds” column, then the “Excluded” column. As in the preceding example this leads us to offer “the”, “me” and “it”, which alphabetically sort to “it”, “me” and “the”.

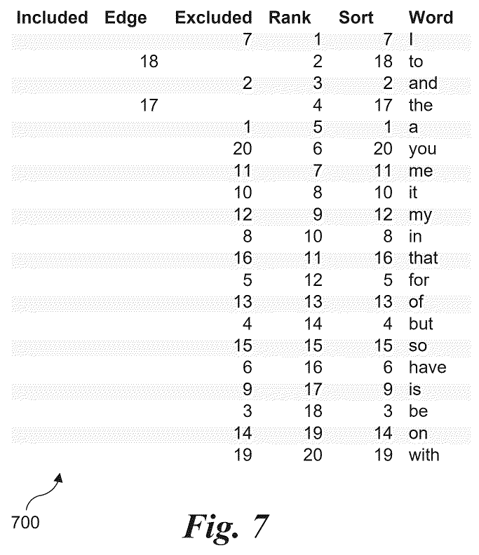

If we continue looking for “this” we will click after “the” in the user interface. The gives us a new lower bound. The unseen upper bound is retained, so we now look for words between “the” and “I”. As shown in Table 700 of FIG. 7, unlike in the preceding example, here there are no words in the list that are between the bounds, so we pick the two boundary words together with the highest ranked word outside the bounds, these are “to”, “the” and “I”, which sort to “I”, “the” and “to”.

The words “the” and “to” in the 20-word dictionary we have worded with sort next to each other, the word “this” is not present in the dictionary. In one embodiment, the user interface can reflect this situation in one of two ways, depending on how it is configured:
No navigation is offered between the two words as there are no words to be offered.
Instead of navigation a means to add a new word is offered.
   The rationale for this behavior is described below.

### Rationale

With each navigation between two suggested words the list of words to offer becomes shorter and shorter and eventually the list of words will become fewer than are needed to fill every row in the user interface. This situation can arise for one of two reasons, either the word does not exist in the dictionary, or the user navigated incorrectly.

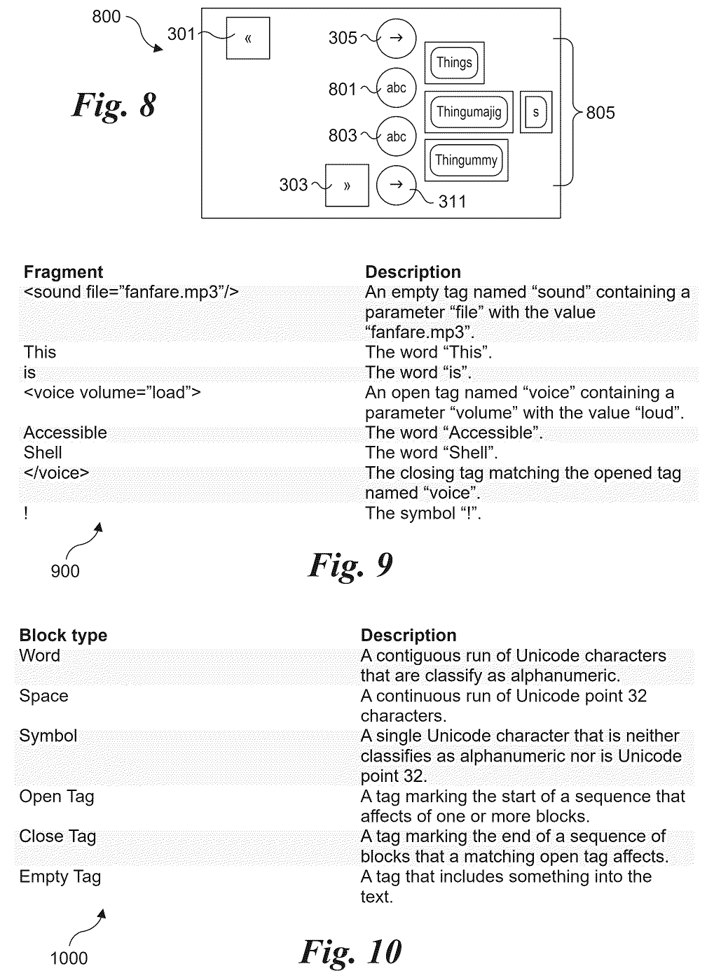

One behavior the user interface can adopt is to offer to allow the user to spell out missing words. This might be represented as shown in UI 800 of FIG. 8. In this example UI, the middle two navigation buttons between suggestions 805 have been replaced with spelling buttons 801 and 803, labeled “abc” (representing a spelling icon).

Spelling out words may be an unexpected behavior for some users, so the user interface can be set to just leave the gap between adjacent words blank, in one embodiment. Also, the adjacent items may not be words (or partial words or phrases), they may be punctuation, formatting, commands, or something else, something that cannot be created; in this case the navigation button(s) will be omitted.

The behavior of offering suggestions in the manner described ensures the user sees where suggestions are adjacent and so knows they are absent. It also allows them to create the missing object if it is required.

If the target word is in the dictionary, but during navigation towards the target word a wrong navigation button is pressed, then the described behavior means the target word will eventually be found. Other means to correct incorrect navigation are available, such as described and illustrated below.

### Blocks

Generally, an application implemented with the AAC accessible shell and/or associated tools/libraries/frameworks etc. will store and manipulate text, as well as other types of data (collectively referred to as text content). Text is represented in different ways depending on where it is being stored and what manipulations are being applied to it. In one embodiment, when stored in a file or the like, text content may be stored in a language similar to XML. The internal representation of text content reflects this association with XML.

A block of text may contain words, punctuation, embedded media (like audio clips) and formatting. An utterance to be spoken by an AAC system might be written in an XML-like language, such as:
<sound file=“fanfare.mp3”/>This is<voice volume=“loud”>Accessible Shell</voice>! This example is merely illustrative of one way text is stored, as the actual mark-up may be different.

Within the AAC application, the example text is represented as a sequence of blocks, such as shows in block sequence 900 in FIG. 9. In one embodiment, the AAC accessible shell supports the use of six kinds of blocks to represent text and other types of data, as shown in Table 1000 in FIG. 10.

One may notice that the block types include a Space type, whereas the example text does not include such a block even though there were spaces in it. This is because single spaces adjacent to other block types are either directly or implicitly represented.

The internal representation of the block types implicitly or explicitly indicates whether the block glues to the block before it and whether it glues to the block following it. Two adjacent blocks where neither block is marked as gluing to the other have a space inserted between them when formatted as text, according to one embodiment.

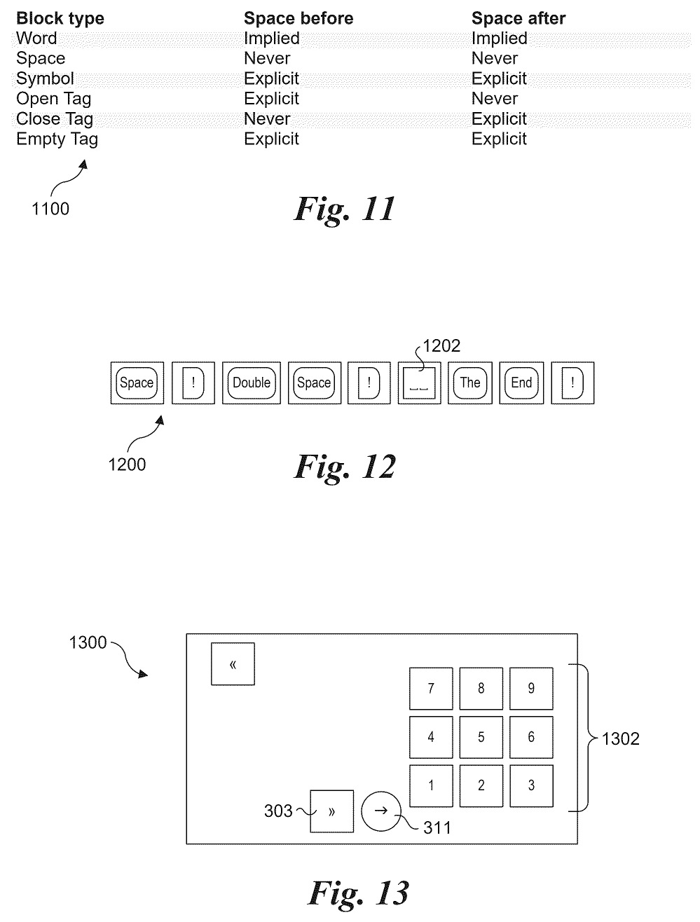

An alternative way of representing this is that blocks implicitly or explicitly indicate if there is an assumed space before and an assumed space after them. A space is inserted between blocks when formatted as text when both have an assumed space on the sides that touch. Where spacing cannot be represented by this logic, an explicit Space block is used. A logic Table 1100 illustrating an exemplary set of rules is shown in FIG. 11.

Spacing may be indicated in the user interface. For example, FIG. 12 shows an example use of text 1200 comprising “Space! Double Space! The End!” with two spaces after “Double space!” In text 1200 implied space is represented by curved tile endings, or alternatively gluing by flat tile endings. Also, where the special case of two spaces occurs a tile or button 1202 containing two visual space characters is shown.

### Tokens and Tokenizers

In one embodiment, when stored in isolation, Block objects will be stored in some direct representation, so words will normally be held in a language like C# as something containing a string type. Several technical reasons mean it is often more efficient in terms of processing time and storage space to represent blocks by an integer.

In one aspect, the implementation of the system includes a tokenizer system in which any given block can be substituted for a token. Any given token can similarly be substituted for a corresponding block. Within the lifetime of a tokenizer, the same block will convert to the same token and the token back to the same block, according to one embodiment.

The Tokenizer exposes two methods for converting from a Block to a Token. Both methods will return the same Token for a Block that has been encountered before. For new Blocks, one method will allocate a new unique Token value for it. The other method will not allocate a new Token value and will indicate that the Block cannot be tokenized.

Two special Token values are defined. A Null token used to mark special cases, like the start and end of a sequence and an Impossible token that is used to indicate when tokenization cannot occur. In addition to their role exchanging between Block and Token types, a Tokenizer can also iterate through tokens in alphabetically sorted order.

For efficiency, one Tokenizer can be created as a child of another. In one embodiment, the parent Tokenizer is treated as read-only and cannot be updated. A Tokenizer that stores all the words in the seed dictionary for a language may require significant effort to sort its contents. In contrast, a child of the seed dictionary may only contain a handful of words that can be sorted rapidly.

In one embodiment the integers that are used as Token values have the following properties:
The Impossible token has the value −1.
The Null token has the value 0.
In a seed dictionary, the most common word in the language will have the value 1.
The second most common word in a seed dictionary will have the value 2.
There will be no gaps in Token values, even when one value is from a parent Tokenizer and another from its immediate child or a further descendant.

Token values are used to decide the likelihood of their corresponding Blocks when no other information is available, the lower value is assumed to be more likely.

### Elementals

Elementals are a class of object that give meaning to Block objects or refine the meaning of lower level Elementals. All Block objects can be associated with an Elemental object, for example all Word blocks will associate with a Word elemental.

An Elemental defines things about blocks, such as:
How to block is converted into text.
The sorting order of a block with respect to another.
If used to represent a button, what action is performed when the button is pressed.

### n-gram Dictionaries

An n-gram contains a collection of Token sequences and a value. In one embodiment the value will be a count of how many times the sequence has been encountered.

One can use an n-gram dictionary to make a prediction for the next token in a sequence by finding the n-grams that match the tail of the sequence, excluding the last token in the n-gram. Sorting the resulting n-grams firstly by their descending length and secondarily by descending count gives the bases for a prediction. The predictions will be the last token in the n-gram and some measure of how likely the prediction is will be indicated by the length of the original n-gram and the count.

This is a primitive but fast way of making predictions.

### Predictions in Accessible Shell AAC

The application uses n-gram dictionaries to make predictions. However, it does so in a novel manner.

Firstly, the predictions are used to create a tree of suggestions.
The already entered text is converted from blocks to tokens and this sequence of tokens is prefixed by a null token; this is the path leading to the node. The path is used to find the highest ranked predictions. The predicted tokens are used to populate nodes of the tree directly under the tree's root node.
Nodes below created children are populated using predictions stemming from the path to the parent plus the predicted token for the parent node.
Nodes are added to the tree one-by-one. The node added at each step will be the node with the highest rank.
Growth of the tree is constrained by the availability of a prediction and the ability of the user interface to format the tree for display. At each step the highest ranked available prediction whose addition to the tree would still allow the tree to be formatted is added.
Tree growth finishes when further predictions are unavailable or when no available prediction results in a tree that can be formatted for the user interface.

Secondly, multiple n-gram dictionaries are used to create predictions.
At each node in the tree a sequence of n-gram dictionaries will be used to generate and score a prediction.
The score for a prediction will consist of a tuple consisting of:
   The index of the dictionary.
   The length of the n-gram.
   The count associated with the n-gram.
   The predicted token.
The highest ranked tuple is the one that can be differentiated by the first of the following criteria:
   The lowest dictionary index.
   The longest n-gram length.
   The highest count.
   The lowest token value.
   Some arbitrary mechanism, such as the least recently found prediction.

Predictions are filtered before they are made. If a prediction for a node is not available, it is ignored, and the next prediction is considered. This typically occurs when a command block is predicted, and that command is not available. The filtering process repeats until an available prediction is found or no further prediction can be found.

All nodes in the tree will normally use the same number of n-gram dictionaries, however, different nodes may use different dictionaries. Typically, the set of dictionaries used to create predictions off the root of the tree will be different from those used to make predictions elsewhere.

The sequence of dictionaries used from the root of the tree may include dictionaries that will suggest words based purely on their frequency of use. The matching dictionary in other nodes may substitute a dictionary in which at least the last item of the path to the node is included. If “I” is the most common word, this prevents a sequence of “I”s being predicted where no other information is available.

A heuristic is applied to children of nodes not directly off the root to prevent the child artificially having a rank higher than its parent. This heuristic may be to reduce the length of the n-gram stored in the score to be no greater than its parent's.

### Hard Coded n-gram Dictionaries

An n-gram dictionary can be hard coded to produce a desired result. For example, FIG. 13 shows a UI 1300 including a keypad 1302 that may be generated by the inclusion of hard coded data.

Using hard coded data like this allows the user interface to be consistent and allows navigation to occur as expected. So, in this keypad example, the missing zero can be found by navigating beyond the non-zero digits (by activating navigation button 311). As throughout most of this disclosure, the screens are far smaller than would normally be encountered, and room for the whole keypad to be displayed would normally be available.

### External Prediction Mechanisms

Other prediction mechanisms are available that create richer and more appropriate suggestions. This is especially true when text is being created in response to other input of which the application has visibility. For example, if the application is responding to text messages or transcribed speech.

To integrate an external prediction mechanism, suggested text from that mechanism is tokenized in the manner described above for applications and then used to build n-grams that all begin with a start of utterance token. For example, if an external prediction mechanism thinks “Hello World!” is a good response and “«” represents the start of utterance token and “»” the end, then a dictionary containing “«Hello”, “«Hello World”, “«Hello World!” and “«Hello World!»” will be built and placed as one of the early dictionaries used for prediction.

The way in which the external prediction mechanism is queried may depend, in part, on the nature of the predictor. A purpose-built predictor may run every time the constructed text changes or navigation between suggestions takes place. Alternatively, a predictor that neither knows about the applications navigation nor takes a predictable amount of time to produce a result may-be called if it is idle and has not been called within a recent set amount of time.

### ChatGPT-Like Integration

Applications built using Large Language Models, such as GPT-3.5 and GPT-4 from OpenAI, LLAMA from Meta, and PaLM2 from Google, are enabled to generate text and other types of contents (image content, speech content, etc.) in response to input content of those types. The most well-known example is ChatGPT, which may be accessed online or may be integrated into an application using a Web service or the like. When sufficient storage and memory is available, a local instance of an LLM-based predictor may be utilized.

While ChatGPT and ChatGPT-like application can generate large amounts of free-form text in response to prompts, they may also be used as an n-gram dictionary by implementing them using a Software as a Service (SAS) architecture and/or may be used to build a local n-gram dictionary.

In one embodiment, when the application starts, an empty n-gram dictionary will be created and an initial request is made to the web client of the service to provide some predicted texts. The empty dictionary will be placed into the sequence of dictionaries used to grow the suggestion tree. When the web client responds, the responses will be packaged into an n-gram dictionary. The next time a step in growing the tree is taken, the new dictionary will replace the empty dictionary, or one previously built from a previous response.

In one embodiment, if requests can be made freely, new predictions will be requested whenever a response is not outstanding, and the constructed text has changed. For example, when there is an Internet connection with sufficient bandwidth and the Web service can generate real-time responses, this approach may be used. If requests are more restricted, new predictions will be requested whenever a response is not outstanding and the current constructed text deviates from what was predicted.

### Learned Dictionaries

In one embodiment, whenever an utterance is completed and rendered in some way, for example spoken, sent, or placed in a document, the utterance is added to a learned dictionary for the user. The blocks are tokenized and n-grams of lengths one to some configured maximum length are created. An initial and terminal token are added to the tokenized utterance and the occurrence count for existing n-grams is incremented or a new n-gram with count one is created.

Some text in the utterance being encoded may be modified. For example, some empty tags contain information that is expanded from a simpler form, specifically sequences of digits are converted into a spoken form like a date or a dollar amount in one embodiment. In the case of these expanded empty tags, these are replaced with empty tags without the data that is being expanded. This means that it is recorded that in this context a telephone number might be required, but not what the telephone number is. If the telephone number is one that is often repeated, then the user can indicate that by converting from an expanding empty tag to actual text.

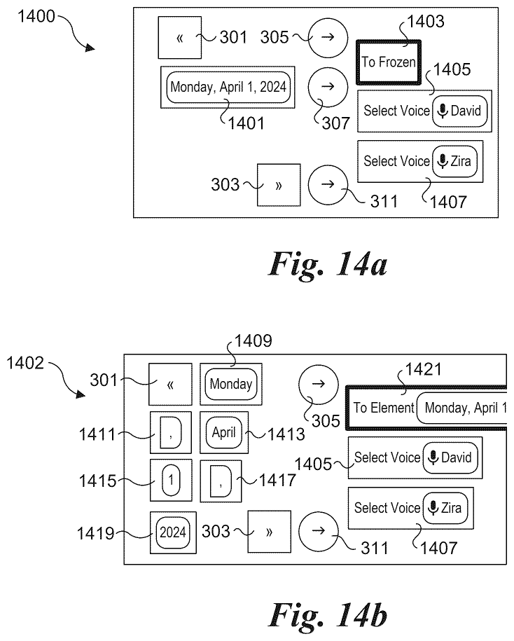

An example of this is illustrated in FIGS. 14a and 14b. In FIG. 14a, a UI 1400 shows an example of an empty tag 1401 containing a date being converted into frozen text in response to selection/activation of a “To Frozen” button 1403. In UI 1402 in FIG. 14b, text correspond to a “Monday” button 1409, a comma button 1411, an “April” button 1413, a “1” button 1415, a comma button 1417, and a “2024” button 1419 are converted to an empty tag by selection/activation of a “To Element” button 1421.

UI's 1400 and 1402 further include two voice selection buttons 1405 and 1407 that enable a user to select a synthesized voice (David or Zira) to verbalize text content.

### Lost Text Learning

Constructed text comprises the items added from the suggestions. In one embodiment, replacing an incorrectly entered word or phrase is a two-phase process. Firstly, the range of the good text (i.e., portion of text from the beginning the user desires to keep) is indicated by selecting the last word that is correct. This action will disable all the items that follow it.

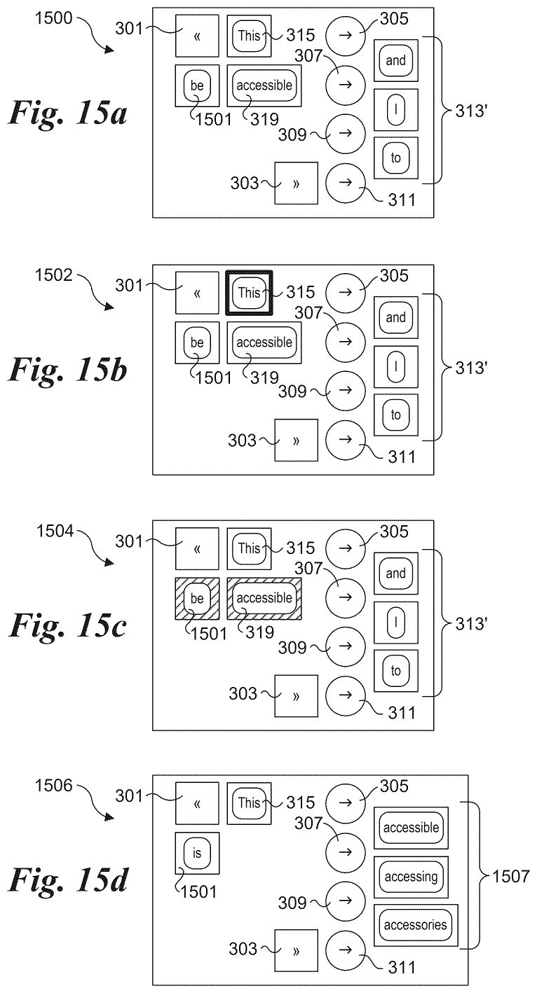

FIGS. 15a-15d show a sequence of UI states demonstrating an example of this concept. We begin with a UI state 1500 in FIG. 15a. As shown, the user has added items (words) “This”, “be”, “accessible”, respectively corresponding to “This” button 315, “be” button 1501, and “accessible” button 319. Since “This be accessible” is grammatically incorrect, the user will want to replace “be” with “is” in this example.

As shown in UI state 1502 in FIG. 15b, the user selects to activate “This” button 315, which is the last word that is correct. Having selected the last good word, the enabled text is just the good text. The potentially unwanted text is displayed as disabled, as shown in UI state 1504 in FIG. 15c.

Selecting and entering a new word will replace the disabled portion of the constructed text. In one embodiment, the suggested text (not shown here) will include versions of the lost text, such as “be accessible” and “accessible” here. In this example, “is” button has been selected and added, as shown by UI state 1506 in FIG. 15d. As further shown in Figure 1506, the updated suggestions 1507 are “accessible”, “accessing”, and “accessories”.

When text is lost in this manner it is added to an n-gram dictionary that appears early in the sequence of dictionaries to use so the lost text can easily be recalled. In one embodiment, a heuristic effort is made to lose text from this dictionary after it is used. This dictionary is cleared whenever the utterance is completed.

### Break and Merge

In the era of word processors before personal computers, text entry was modelled more after manual typewriters than the prevailing WYSIWYG model. One leading system made by Wordplex did not have a text insertion model for entering text. Text was always displayed fixed width, not proportionally spaced as most modern fonts. Typing text such that it reached the edge of the screen would cause the last word to wrap and a new line be inserted, much as WYSIWYG word processors. However, if the cursor was moved somewhere inside existing text, typing would overwrite the previous text character-by-character.

Inserting a word in the Wordplex system comprised several steps. A Break key would be pressed, which split the line into two at the location of the cursor. The missing text could then be entered. Finally, a Merge key joined the two lines back together and rearranged the text that followed so that the paragraph's lines wrapped at the correct positions.

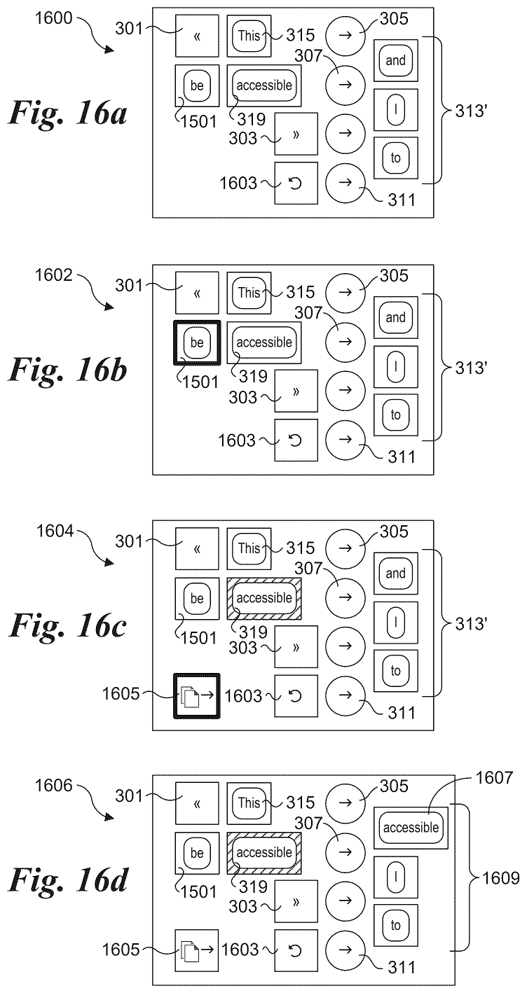

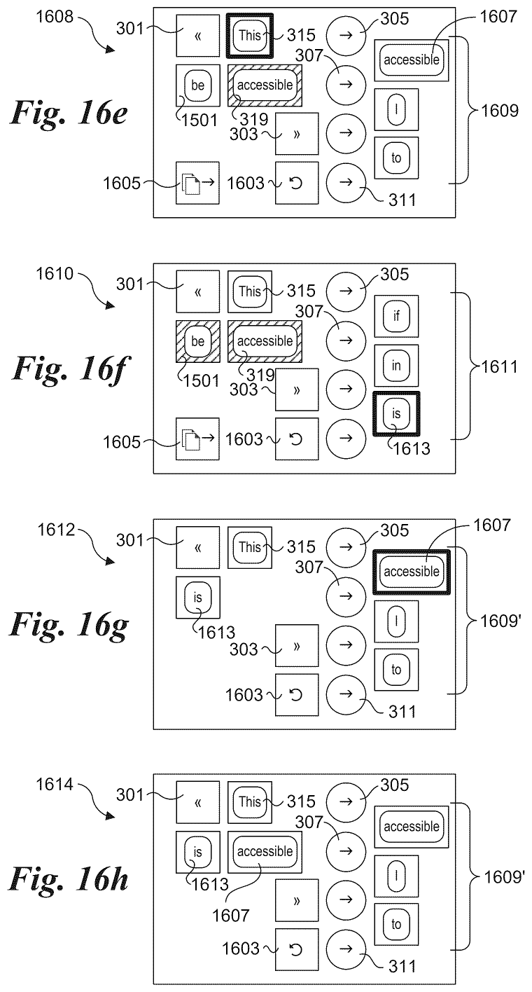

In one embodiment, the AAC application implements a method inspired by the Wordplex approach. There is a toolbar available that contains two buttons that are roughly analogous to the Wordplex Break and Merge. The Break and Merge operations are described and illustrated in the UI state sequence shown in FIGS. 16a-16h.

As shown in UI state 1600 of FIG. 16a, the user has added items (words) “This”, “be”, “accessible”, respectively corresponding to “This” button 315, “be” button 1601, and “accessible” button 319. UI state 1600 is similar to UI state 1500 in FIG. 15a, but with the addition of an undo button 1603 (included in this example but otherwise not used). As before, since “This be accessible” is grammatically incorrect, the user will want to replace “be” with “is” in this example.

As shown in UI state 1602 in FIG. 16b, the user selects “be” button 1501, which corresponds to the last part of the text to lose, just before the part of the text to keep. As shown in UI state 1604 of FIG. 16c, accessible button 319 is shown as disabled and an add to dictionary button 1605 has been added to the user interface and has been selected by the user. The selection of add to dictionary button 1605 saves the text “accessible” to the n-gram dictionary.

The saved text “accessible” will then appear in the updated suggestions, as shown in UI state 1606 of FIG. 16d, where an “accessible” button 1607 has been added to updated suggestions 1609, while add to dictionary button 1605 is returned to its unselected state.

Next, as shown in UI state 1608 in FIG. 16e, the user selects “This” button 315, which is the last part of the text the user would like to keep. As shown in UI state 1610 in FIG. 16f, “be” button 1501 and “accessible” button 319 are both shown as disabled. In addition, updated recommendations 1611 are provided including “if”, “in”, and “is” buttons, with the “is” button 1613 highlighted to indicate this has been selected by the user.

As shown in UI state 1612 in FIG. 16, “is” button 1613 has been added in the text entry area after “This” button 315, and the word that was lost, “accessible”, is immediately available for resurrection and is added to updated recommendations 1609′. As further shown by the highlight for “accessible” button 1607, the user has selected this button. As shown in the last UI state 1614 in FIG. 16h, “accessible” button 1607 has been added, with the entered text items reciting “This is accessible.”

In one embodiment, the system toolbar contains a button that removes the saved text from the merge directory. Alternatively, a heuristic may be used to automatically remove it.

### Formatting the Suggestion Tree

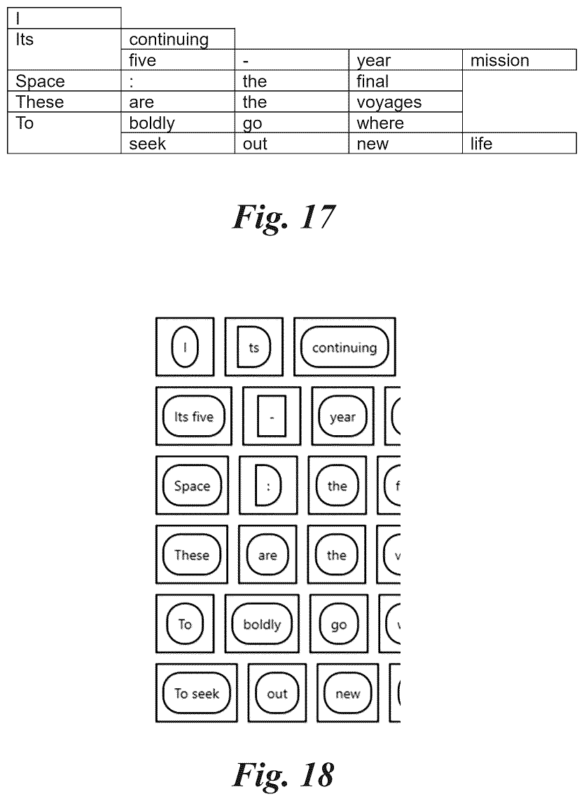

FIG. 17 shows an example suggestion tree from an English language text suggester that is expecting the opening monologues from the original and next generation Star Trek televisions shows. Excluding the unshown root, there are 23 nodes in this tree. These nodes will translate into the same number of buttons.

### Tree to Buttons

The example tree above will translate into the following buttons.
[I] [ts] [continuing]
[Its five] [-] [year] [mission]
[Space] [: ] [the] [final]
[These] [are] [the] [voyages]
[To] [boldly] [go] [where][To seek] [out] [new] [life]

There are three types of buttons. Normal buttons, the majority here, simply contain a representation of the node to which they apply. For the nodes containing “Space”, “:”, “the”, and “final” translate into buttons with the same content. Compound buttons occur when a node is not the first node of its parent, and its parent is not the root. Compound nodes contain a representation of all the nodes between the root and the represented node, excluding the root but including the node itself. This occurs in the example for “Its five” and “To seek”. Fractured buttons occur when the preceding peer node is a leaf and contains a representation that is a prefix of the node. In the example this occurs only in the case of “I” and “Its”.

The use of fractured buttons is optional and a parameter to the formatter. Their use allows for more options to be displayed. An option to the code that grows the tree is the inclusion of multiple children for nodes other than the root. If the tree is grown with only the root having more than one possible child, then compound buttons will not occur.

Notice that the button corresponding to a node is uniquely identifiable as one of the three types, with the type to be used is unambiguous. The number of rows to display the nodes corresponds to the number of leaves in the tree less those leaves that are the prefixes of their peers. Because of this a tree with multiple nodes off the root can correspond to a single row, while a tree with a single node off the root can correspond to multiple rows.

### Final Layout

The buttons are rendered on screen from left-to-right or right-to-left depending on the application and language in use. For English text suggestions they will appear left-to-right, for Arabic or Hebrew they will appear right-to-left.

The buttons will be formatted to some visual appearance style. The space occupied by the buttons will be of a size dictated by an external system, for example the size of the operating system window. In some embodiments, it is possible that a given tree will layout to an arrangement where some buttons are partially or completely outside the target area. In one embodiment the layout system provides a means to indicate this. The example used above might format to the layout shown in FIG. 18.

Notice that all 23 buttons are at least partially visible. Some of the leaf buttons are truncated to fit in the available space. As described elsewhere, the code that grows the suggestion tree uses feedback from the layout system to know when to stop adding nodes to the tree.

### Adaptive Dwell

A button on a touch screen can be activated by briefly touching the button with a finger; the computer sees the brief appearance of the touch point and registers it as the activation of the button.

Similarly, a button can be pressed using a mouse or similar device by moving an on-screen cursor over the button and briefly pressing a button; the computer tracks the position of the cursor and activates the object under the cursor when the button is pressed.

In the case of a mouse often there is on screen feedback to indicate the availability of activation and the associated action. For example, the appearance of a button may change when the cursor is above it, and if it dwells for a short period of time a tooltip containing text descriptive of its action may appear.

In some accessible scenarios activation needs to be accomplished using a pointer alone. In this case the activation of the button needs to be achieved by noting the dwell of a pointer over the button, similar in nature to the mechanism that shows a tooltip in more usual situations.

Interfaces built to accept eye gaze as input may use these mechanisms. The point at which the user's gaze on the screen is followed and if it dwells for a period of time over a button, that button's action is triggered.

The application being described in this patent may be used with an analogue controller, such as that offered by an Xbox Adaptive Controller. One mechanism may be to use the left analogue trigger to select among the vertical stack of navigation buttons, and the right trigger to select among the first word suggestions. Alternatively, one trigger could be used to select among both the navigation and first word suggestions using a zig-zag pattern. In these scenarios, the selected button would activate when the button remains selected for a period of time.

Considering the eye gaze scenario, a common problem is that the tracker is calibrated to the user at the start of the day and then provides accurate feedback on the user's gaze. However, over time, the accuracy of the gaze reports reduces, the reports become biased away from the true gaze position and the is more noise in the signal. This can be because the tracker moves relative to the screen or user, it can be because lighting changes (e.g. the sun moves), it can be because the user becomes tired or a variety of other causes.

In some embodiments, an application may dynamically create its user interface. The application may be implemented to enable the user to choose the size of button that best suits them. For users of eye gaze or other analogue inputs, one of the considerations in that size is the smallest button they can reliably trigger.

An option opened up by the dynamic nature of the user interface here is that the quality of the analogue signal can be measured and the size of targets in the user interface adjusted.

There are two components to implementing a dwell-based activation scheme. Firstly, there is identification of the target. Secondly, there is detecting the dwell, specifically the start and end of a dwell.

In the case of eye gaze, detecting the target involves identifying the button being gazed upon at the start of the dwell and then checking the same target is being substantively gazed upon during the dwell. The button at the current gaze position can be identified by searching through all the possible buttons and finding the one that occupies that position on screen. (For example, WPF and other frameworks under Windows offer a function VisualTreeHelper.HitTest that returns a list of controls under a given point on a window.) Because the user is supposedly dwelling, it can just be assumed the gaze point remains within the identified button, or it can be regularly checked and the dwell cancelled if points outside the button at reported.

The dwell itself can be identified as some measure of velocity of the gaze point falling below a given threshold and remaining below another threshold for a period of time. Examples of velocity measures include:
The distance of the most recently reported gaze position from the position reported a given time ago.
The standard deviation of the points reported over a short period of time.

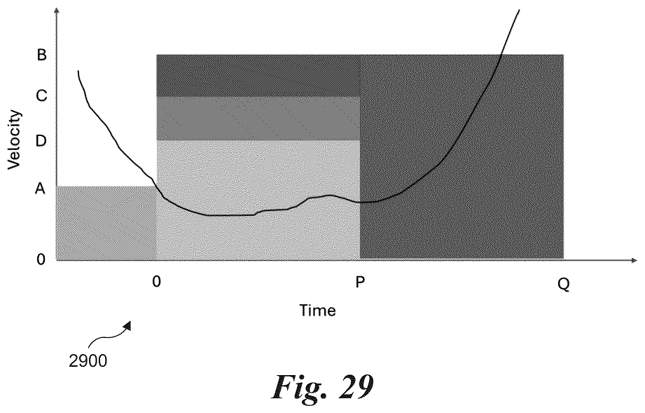

For example, dwell might be detected as in diagram 2900 shown in FIG. 29. Velocity falls below a threshold A at time 0 and remains below threshold B for a time P. The button's action can be fired at time P.

An extension of this logic would require the point's velocity to increase above threshold B by time Q before the button is fired. This would allow inadvertent activations of the button to be detected and cancelled. (If the pointer were a traditional mouse, activation thus occurs when the mouse moves onto a button, pauses, and then leaves. If the mouse is left over a button, perhaps unintentionally, no activation occurs.)

Visual feedback would normally be given for the progress of the dwell if it occurs over a button.

Adaptive Dwell modifies the application such that:
The height of buttons is determined by dividing the height of the available display by a number, this number most easily labelled as the number of rows.
The thresholds for activating a button are determined by some function of the button height, perhaps being proportional to the height of the buttons or by looking into a table of appropriate values for the number of rows.
Two more threshold values are introduced, C and D, being successively smaller than D.

Dwell activation then occurs as described above, however when a button is activated:
The actual velocity V achieved during the activation is calculated, this might be the velocity presented from time 0 to time P, or it might be the minimum velocity reported from some time after 0 but for the same duration.
A counter K is introduced, initially set to zero.
When activation occurs with V between B and C, K is set to the greater of 1 and the current K+1.
When activation occurs with V between C and D, K is set to zero.
When activation occurs with V below D, K is set to the greater of 0 and the current K−1.

Should K become greater than some configured value, this indicates the user may only just be able to activate buttons at the current size. To fix this, the number of rows will be reduced by one, the thresholds recalculated, and K reset to zero.

Should K become less than some configured value, this indicates the user is well able to activate buttons at the current size. To take advantage of this, the number of rows will be increased by one, the thresholds recalculated, and K reset to zero.

A further constraint imposed on the system will be a maximum and minimum size that buttons can grow and shrink to. This prevents buttons becoming too large to present a useful user interface nor too small to perhaps be read.

### Example Eye Tracker Implementation

In some embodiments, user input is facilitated through the use of eye tracking means using associated hardware and software. Eye tracking hardware is available from several manufactures, including Tobii, IRISBOND, Eyegaze, EyeTech Digital Systems, eyeV Gmbh, and GazeFirst Gmbh. Software associated with eye tracking hardware may be provided by the hardware manufacturer and/or a third-party, such as Smartbox, Optikey, Project Iris, and FreePie. Additionally, MICROSOFT® provides software for use with WINDOWS™ operating systems that may be used with eye-tracking hardware provided by one or more manufacturers.

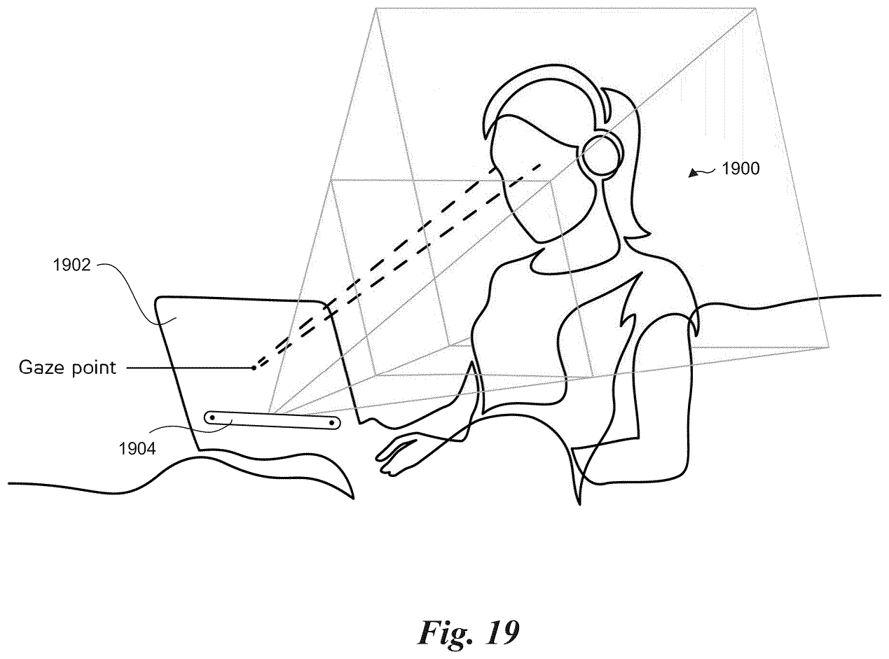

FIG. 19 shows a high-level overview of an implementation employing eye-tracker hardware and associated software. In FIG. 19, a user 1900 interacting with a computer 1902 through use of an eye-tracker 1904. Eye-tracker 1904 tracks the eyes of user 1900 to establish a gaze point corresponding to an interpretation of where user 1900 is focusing on the user interface of the application (e.g., an AAC application) that is displayed to user 1900.

Techniques for performing gaze-tracking and implementing a computer-human interface using eye tracking hardware and associated software are known in the art. For example, non-limiting examples of such techniques are disclosed in U.S. Patent Publication No. US20210325962A1, INTELLIGENT USER INTERFACE ELEMENT SELECTION USING EYE-GAZE, which is incorporated by reference herein.

### Example AAC Application

The preceding user interface examples are simplified, showing a smaller UI than would be present in an actual implementation. Under a typical implementation, the user interface would occupy a significant portion of the display screen for the computing device running the application. For example, for an implementation on a tablet, the UI would occupy an amount of the display screen area occupied by applications running on the operating system for the tablet (e.g., WINDOWS™, ANDROID®, APPLE® iPadOS applications). Tablet display screen sizes may vary depending on the particular model and manufacturer, but may generally range from 10-13 inches diagonally, noting that there is no limit on what display screen size may be used. Laptops and notebooks and the like (e.g., Chromebooks) generally have screen sizes from 12-17 inches, recognizing again that this range is exemplary and non-limiting. In some implementations, other sizes may be used.

FIG. 20 shows an initial user interface 2000 for an example WINDOWS™ application, running in a window 2002. In this example, the display of the computing device is in a landscape orientation. UI 2000 includes a text entry area 2004 including start and end buttons 2006 and 2008. An initial set of suggestion 2010 comprising suggestion buttons are arranged in rows toward the right side of UI 2000. The first suggestion buttons in each row form a column, with a plurality of navigation buttons 2012 being disposed in an adjacent column where the navigation buttons are vertically interposed between the rows of suggestions 2010 with a top navigation button 2014 adjacent and vertically disposed above the first row of suggestion buttons and a bottom navigation button 2016 adjacent and vertically disposed below the last row of suggestion buttons.

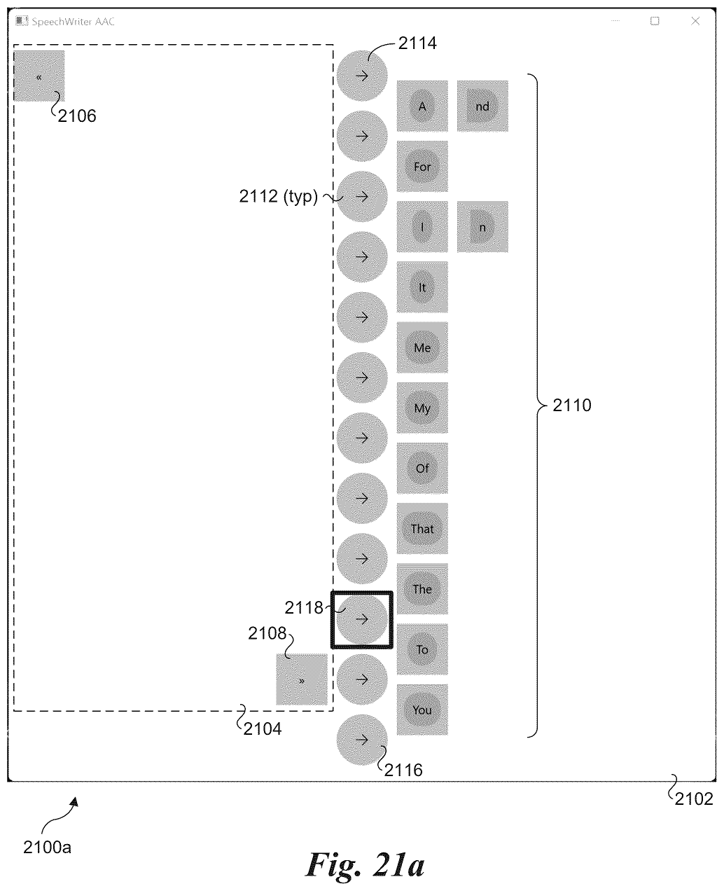

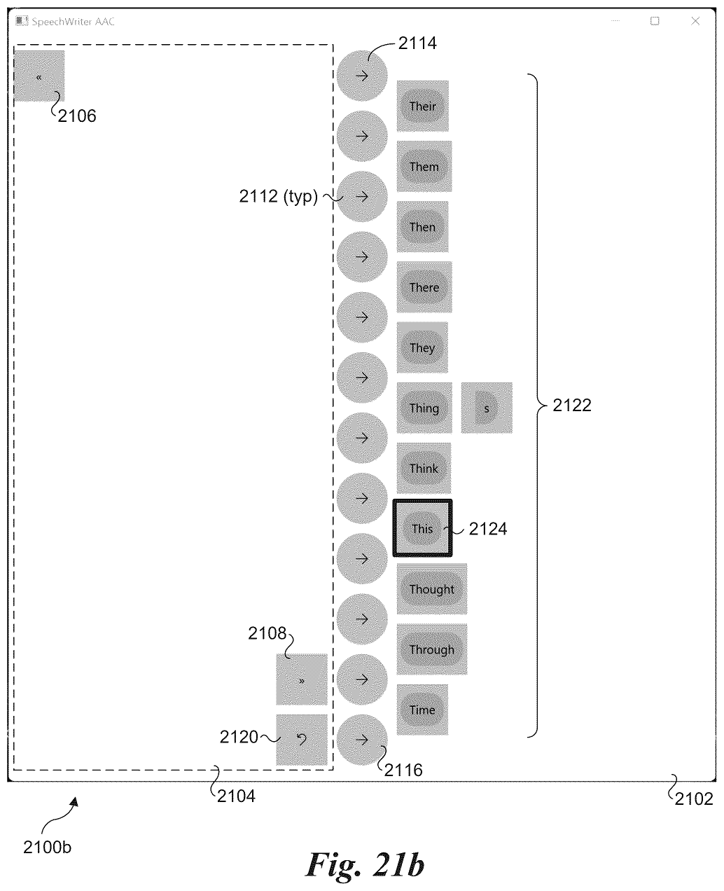

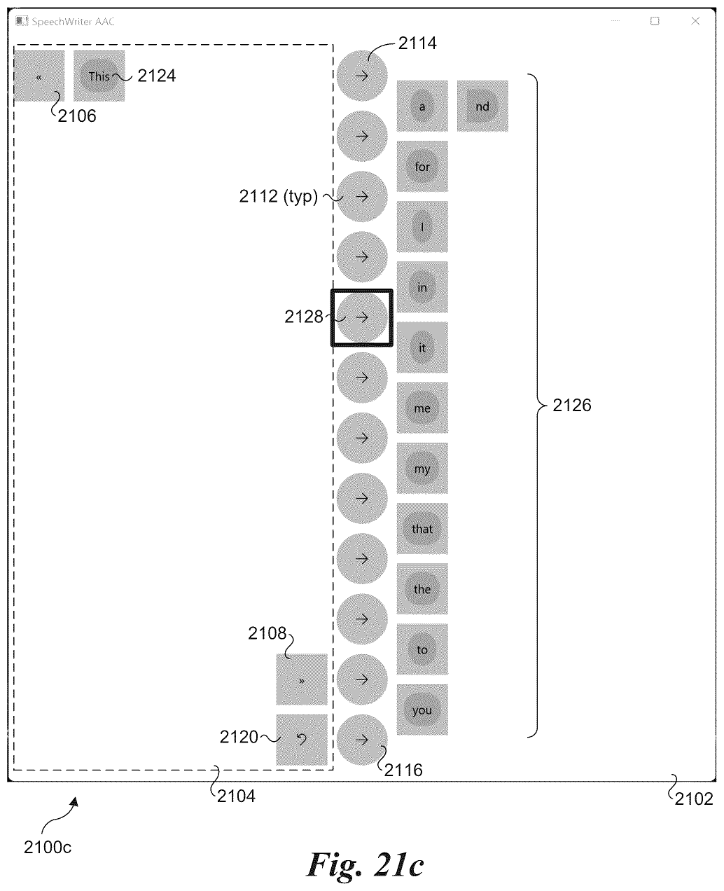

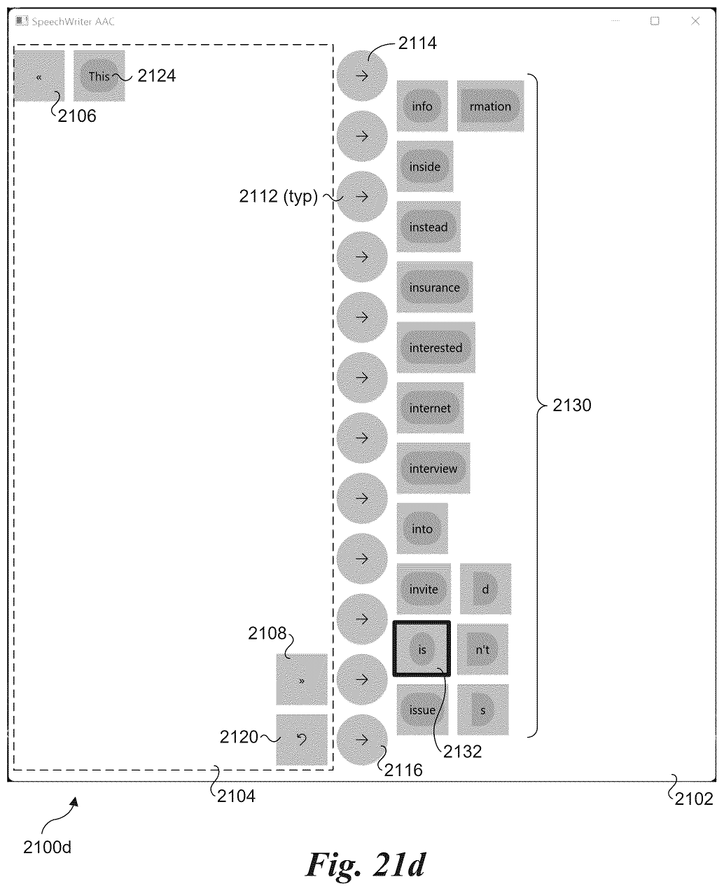

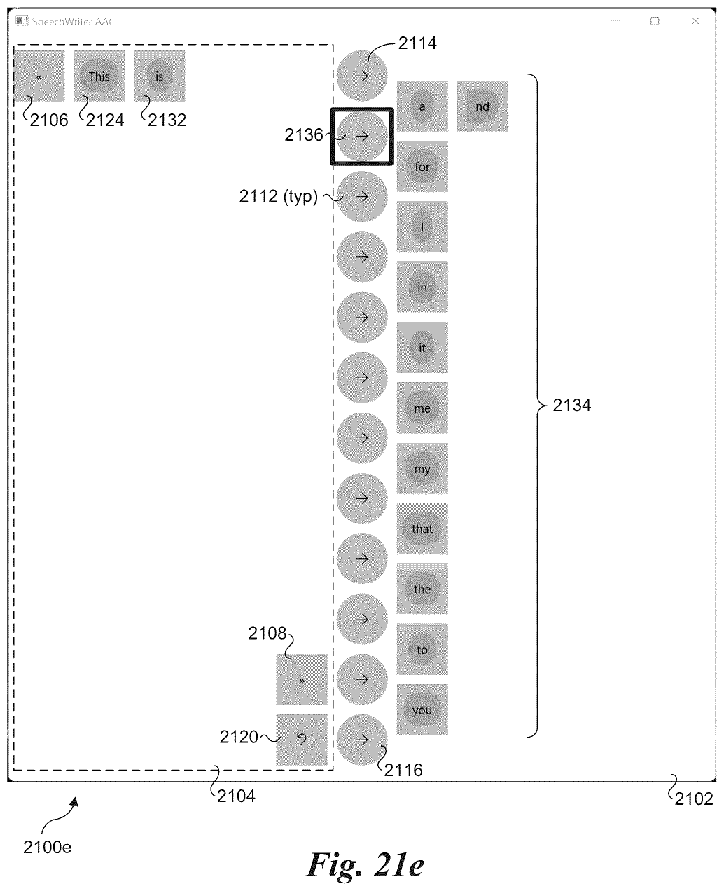

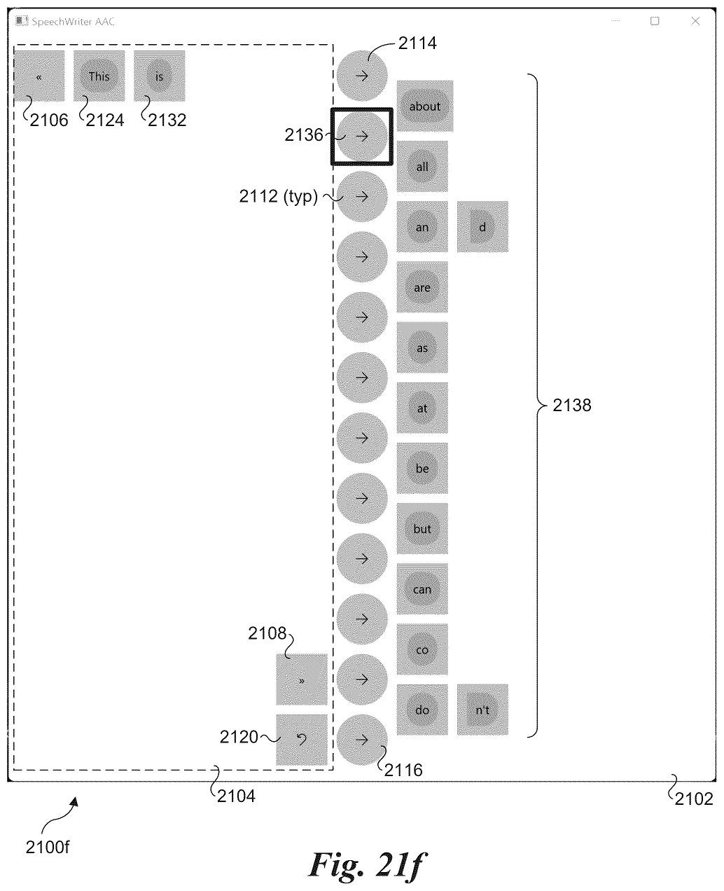

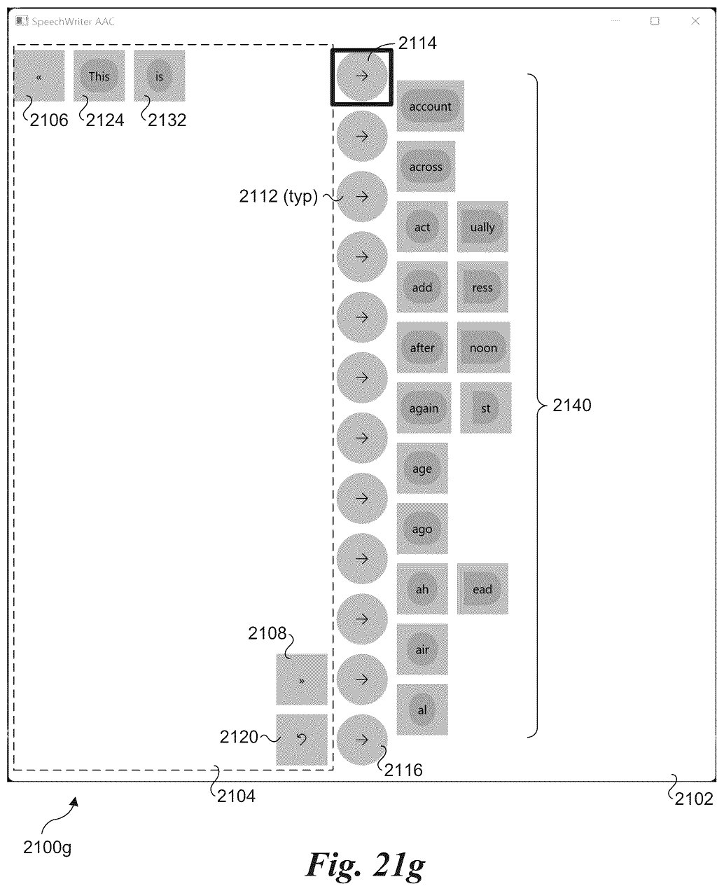

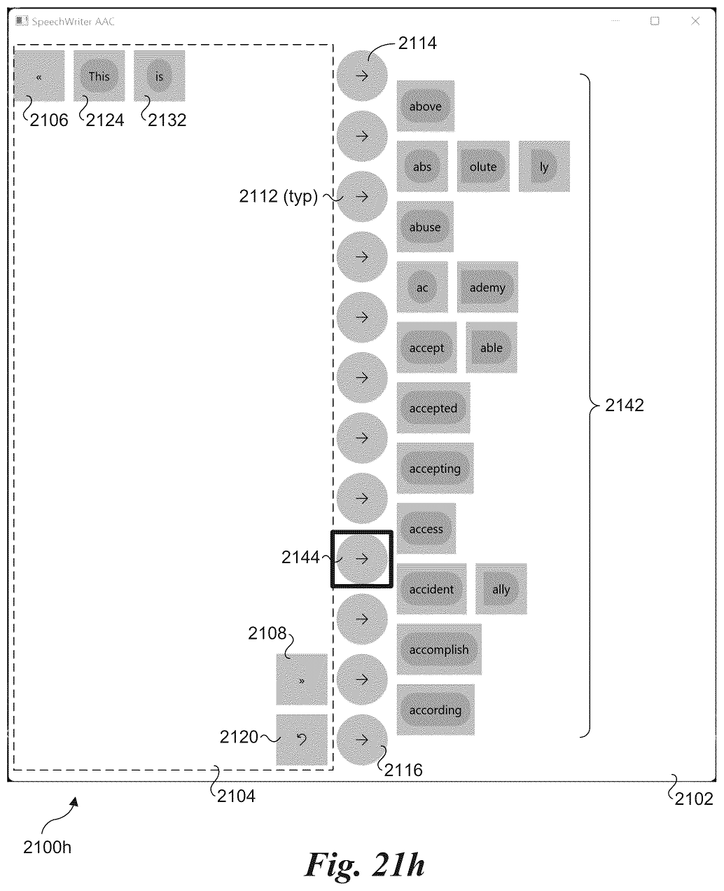

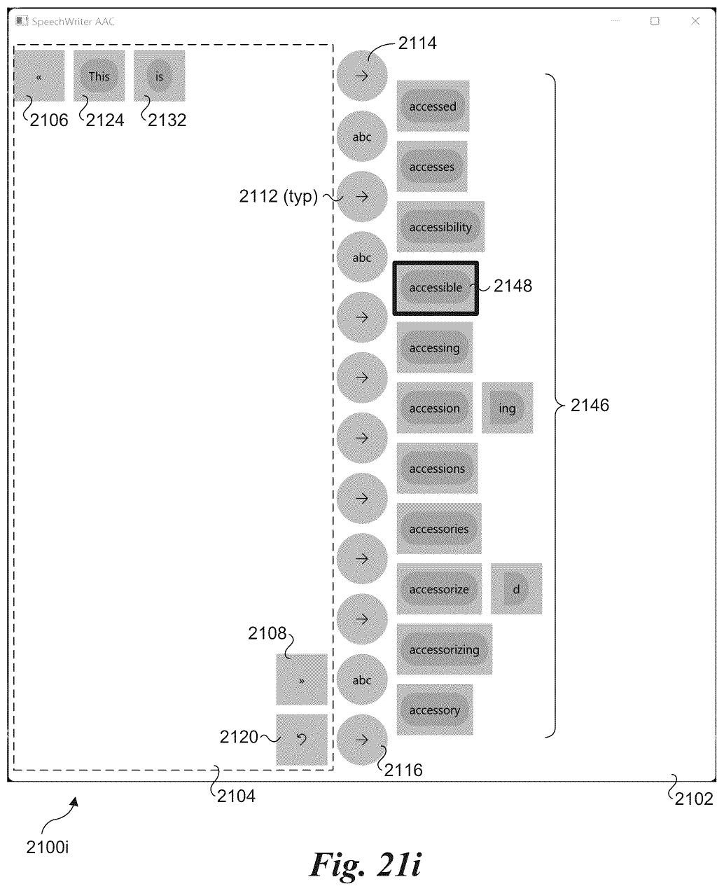

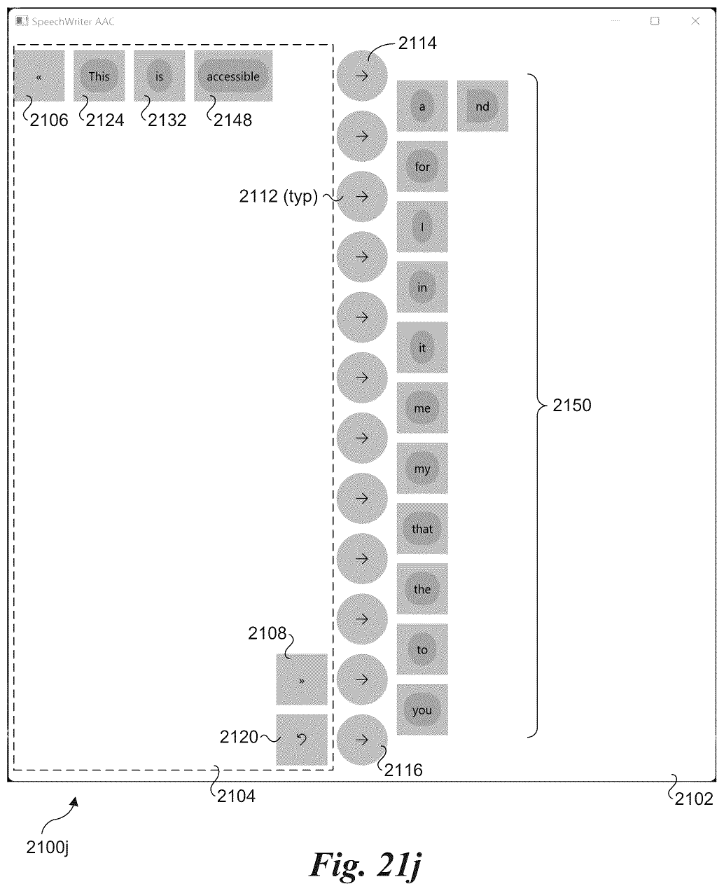

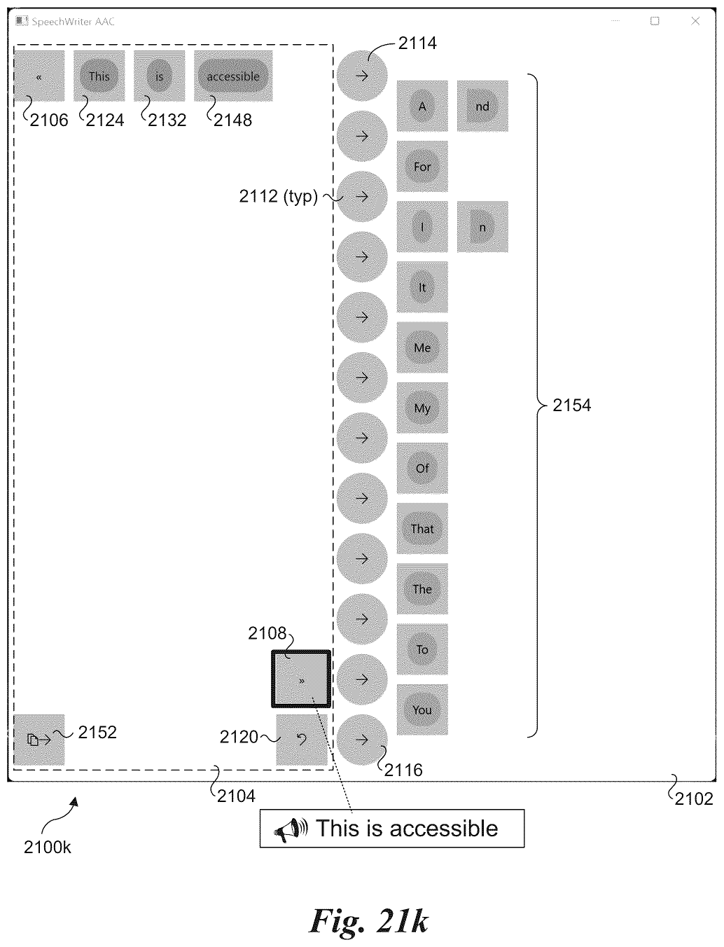

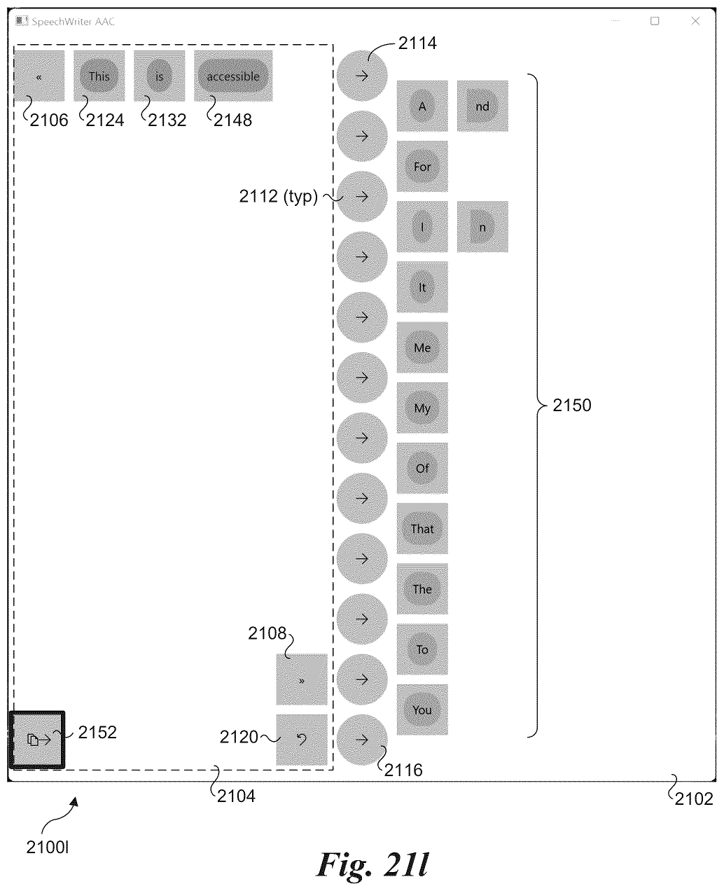

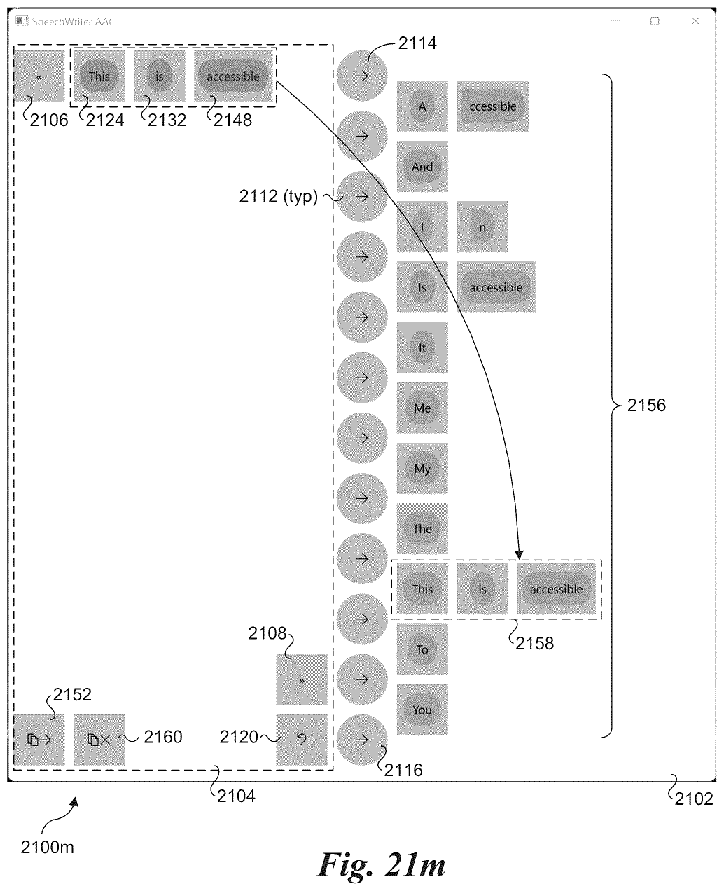

A second UI sequence for entering “This is accessible” is shown in FIGS. 21a-21j, beginning with UI state 2100a in FIG. 21a. UI state 2100a was obtained using the WINDOWS™ application of FIG. 20 by resizing window 2002 to have a portrait-type layout, now numbered window 2102. Also, in FIG. 21a, each of the buttons in FIG. 20 have also been renumbered to replace the first two decimals “20” with “21” such that UI state 2100a includes a text entry area 2104 including start and end buttons 2106 and 2108. An initial set of suggestion 2110 comprising suggestion buttons are arranged in rows toward the right side of UI 2100a. The first suggestion buttons in each row form a column, with a plurality of navigation buttons 2112 being disposed in an adjacent column where the navigation buttons are vertically interposed between the rows of suggestions 2110 with a top navigation button 2114 adjacent and vertically disposed above the first row of suggestion buttons and a bottom navigation button 2116 adjacent and vertically disposed below the last row of suggestion buttons.

Window 2102 is illustrative of an application UI as might appear on a screen having a portrait orientation. Optionally, window 2102 could be used on a computing device with a relatively larger screen, such as a 15-17″ laptop or a monitor used with a desktop-class or all-in-one computer running in a window 2102.

While in UI state 2100a, the user will begin the text entry sequence by selecting/activating a navigation button 2118. In this example, user selection/activation of buttons is highlighted by using a square or rectangle, such as shown in FIG. 21a. Generally, the use of some form of highlighting for the user interface is optional. Under some implementations, such as using eye-tracking, it may be desirable to let the user know where the application (in combination with the eye-tracking hardware and software) senses the user is focusing. For user input using a pointing device or a touchscreen interface, the use of highlighting will be left to the developer.

In response to user selection/activation of navigation button 2118, the UI state will be updated to a UI state 2100b in FIG. 21b. An undo button 2120 has been added in UI state 2100b, as well as an updated set of suggestions 2122. Notice, the updated set of suggestions 2122 now includes a “This” suggestion button 2124, which is highlighted to indicate the user has selected/activated the suggestion button.

In response, the UI state is updated to UI state 2100c shown in FIG. 21c, which shows an instance of “This” suggestion button 2124 has been added to text entry area 2104. In application embodiments employing color, the color of the oval around the text of buttons that are added to text entry area 2104 is changed (from the oval colors used for the suggestion buttons), as depicted by the lighter shade of gray. UI state 2100c also includes updated suggestions 2126. The next word to enter is “is”, which isn't among updated suggestions 2126, but is between the “in” and “it” suggestion buttons. Accordingly, the user will select/activate navigation button 2128, as shown.

In response, the UI state is updated to UI state 2100d shown in FIG. 21d, which has updated suggestions 2130 including an “is” suggestion button 2132 that is selected/activated by the user. Like before, in response to selection/activation of “is” suggestion button 2132 an instance of this button is added to the text entry area 2104, as shown in UI state 2100e in FIG. 21e.

UI state 2100e also includes updated suggestions 2134. The next word to add is “accessible”, which is between the “a” and “for” suggestion buttons in updated suggestions 2134. Accordingly, the user will select/activate a navigation button 2136, as shown, which will cause the set of suggestions to update, as shown by updated suggestions 2138 in UI state 2100f in FIG. 21f. Since “accessible” is between the “about” and “all” suggestion buttons, the user will again activate/select navigation button 2136, as shown in FIG. 21f.

Activation/selection of navigation button 2136 will cause the UI state to update to UI state 2100g shown in FIG. 21g, which includes updated suggestions 2140. Since “accessible” is before “account”, the user will activate the top navigation button 2114, leading to a UI state 2100h shown in FIG. 21h. Since accessible is between the “access” and “accident” suggestion buttons in updated suggestions 2142, the user will activate a navigation button 2144, as shown.

The resulting UI update is shown in FIG. 21i as UI state 2100i, which includes updated suggestions 2146. Among the updated suggestions is an “accessible” suggestion button 2148 that is selected/activated by the user, as shown. As before, this will add an instance of “accessible” suggestion button 2148 to text entry area 2104, as shown in the updated UI state 2100j in FIG. 21j including updated suggestions 2150. This completes entry of the phrase “This is accessible”.

In connection with entering text and phrases, users are enabled to select what to do with the text content that has been entered in text entry area 2124. For example, the user may wish to have the entered text content verbalized as spoken text using a synthesized voice. In the example, selection/activation of end button 2108 will cause the application/system to perform a text-to-speech operation to output the text content as spoken words, as shown in UI state 2100k in FIG. 21k. As also shown, the shading of the ovals for the “This”, “is”, and “accessible” buttons 2124, 2132, and 2148 is darkened to show this text has been spoken, and suggestions 2154 have been updated.

As further shown, an add to dictionary button 2152 has been added to UI state 2100k. In UI state 2100l the user as selected/activated add to add to dictionary button 2152, with the result shown in UI state 2100m of FIG. 21m. As illustrated, in updated suggestions 2156 suggestion buttons 2158 corresponding to “This”, “is”, and “accessible” buttons 2124, 2132, and 2148 have been added. UI state 2100m also includes a remove from dictionary button 2160 that enables the last entry(ies) added to the dictionary to be removed.

As described and illustrated above, text-to-speech functionality may be implemented to enable users to provide verbal communications based on text entered via the user interface. Software for facilitating text-to-speech communication may be available as part of an operating system (e.g., all of MICROSOFT® WINDOWS™, ANDROID®, and APPLE® iOS/iPadOS operating systems have built-in support for text-to-speech communication). Third-party text-to-speech software may also be used, such as provided by Balabolka, for example.

### Initial User Interface Using Hard-Coded Dictionaries

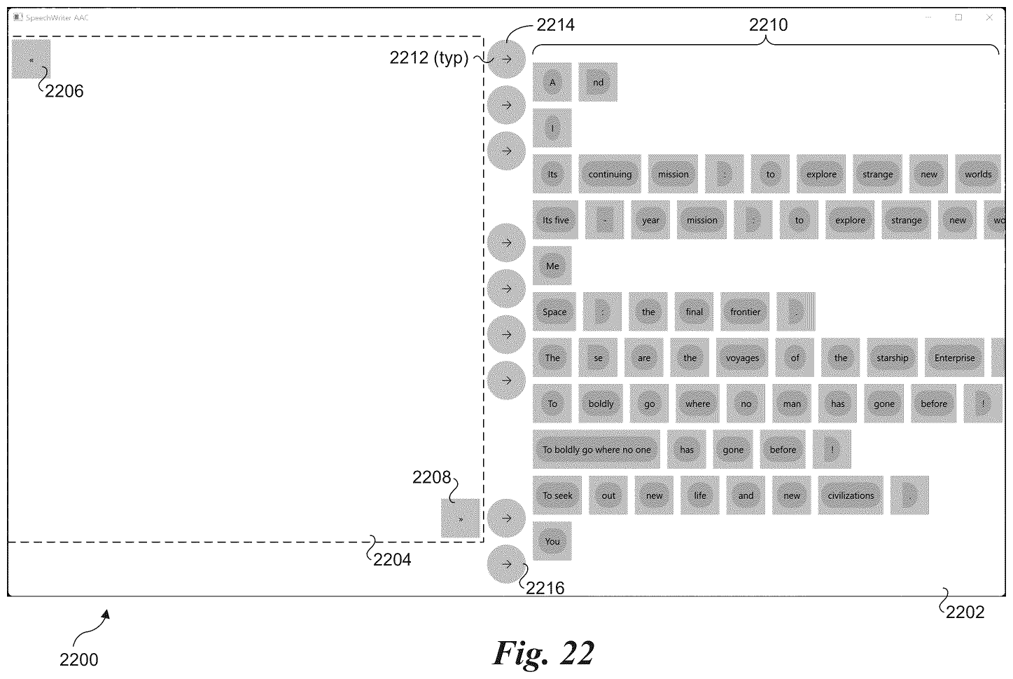

FIG. 22 shows an initial user interface 2200 for second example WINDOWS™ application, running in a window 2202. UI 2200 includes a text entry area 2204 including start and end buttons 2206 and 2208. An initial set of suggestion 2210 comprising suggestion buttons are arranged in rows toward the right side of UI 2200. As before, the first suggestion buttons in each row form a column, with a plurality of navigation buttons 2212 being disposed in an adjacent column where the navigation buttons are vertically interposed between the rows of suggestions 2210 with a top navigation button 2214 adjacent and vertically disposed above the first row of suggestion buttons and a bottom navigation button 2216 adjacent and vertically disposed below the last row of suggestion buttons.

User interface 2200 illustrates an example of an application that includes an initial set of suggestions that are derived, at least in part, from one or more hard-coded n-gram dictionaries. For instance, in this example the words in the predictions come from three n-gram dictionaries:
A dictionary of hard coded predictions consisting of the opening monologues to Star Trek and Star Trek: The Next Generation, chosen because the two monologues are similar but not identical.
A dictionary of the text the user has previously spoken, here the single phrase “This is accessible” (as occurs elsewhere in this document).
A dictionary of English words ranked by their frequency in some unspecified body of text.

From the Star Trek dictionary is a hard coded stand-in for predictions made by an AI system. The sentences are coded so as to be fixed to the start of an utterance. The sentences visible here are:
From Star Trek
   Space: the final frontier.
   These are the voyages of the starship Enterprise.
   Its five-year mission: to explore strange new worlds.
   To seek out new life and new civilizations.
   To boldly go where no man has gone before!
From Star Trek: The Next Generation
   Space: the final frontier.
   These are the voyages of the starship Enterprise.
   Its continuing mission: to explore strange new worlds.
   To seek out new life and new civilizations.
   To boldly go where no one has gone before!
      Both monologues share their first, second and fourth lines.

The third lines in the original series refers to “Its five-year mission”, whereas the rebooted series refers to “Its continuing mission”. This accounts for the first gap in the navigation buttons where both forms following “Its” are available, the original “Its five” start is compounded into a single button as “Its” following by other forms is covered by the first listed variant.

Similarly, originally the mission was “to boldly go where no man” has gone before, but this became “to boldly go where no one” had gone. The offering of both forms can be seen with the compound “To boldly go where no one” button below the one-word-per-button offering of the original form. This phrase also compounds with the shared “To seek out new life” line, so it to is shown with a compound “To seek” button.

### Head Up Display

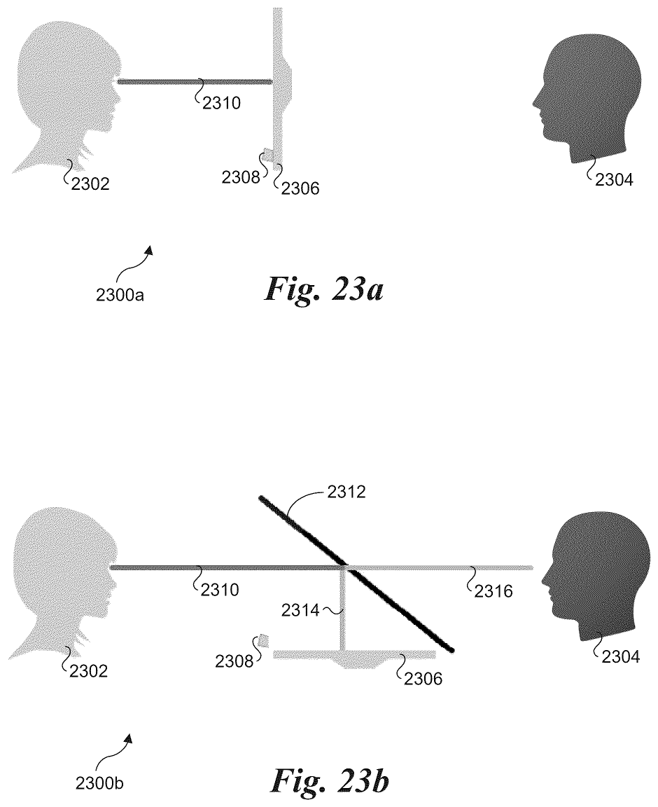

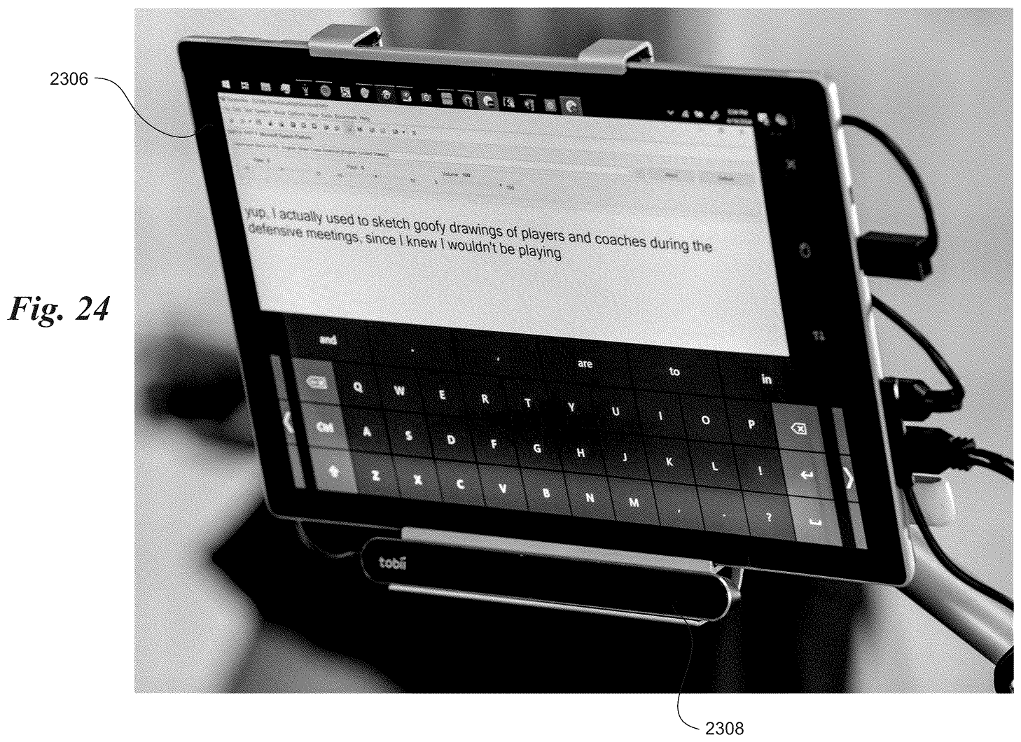

When used for face-to-face communication the display used to drive an AAC device can be an added obstacle to natural communication as it can put an opaque obstacle between the conversing people. This is illustrated in FIGS. 23a and 24. As shown in a diagram 2300a in FIG. 23a, a first person 2302 uses an AAC system including a tablet 2306 and eye tracker 2308 to communicate with a second person 2304. The problem is first person's 2302 line of sight 2310 is blocked by tablet 2306, preventing the first and second persons from having a line of site conversation. FIG. 24 shows further details of the view the first person would have. As illustrated, tablet 2306 blocks the line-of-sight view with the second person, who is shown (blurred) in the background.

This issue can be alleviated by using an autocue set-up, like would be used when public speaking or piece to camera, whereby a half-silvered mirror reflects an image of the computer screen, so it is visible to the user but, generally, not other people. Example situations where this type of display are encountered include the head up displays (HUDs) that have long-been used in military aircraft and more recently have been introduced in various models across a spectrum of auto manufacturers.

An example of an autocue is shown in a diagram 2300b in FIG. 23b where the first and second persons 2302 and 2304 are located in the same respective positions as in FIG. 23b. Tablet 2306 is rotated in a horizontal orientation, with its display content projected along an axis 2314 perpendicular to the table. A half-silvered mirror 2312 is disposed at an angle such that a virtual image appears in the line-of-sight 2310 of person 2302. Meanwhile, since half-silvered mirror is transparent along line-of-sight 2310, person 2310 is able to see person 2304 along an extended line of sight 2316.

Because the display is viewed in a mirror the displayed image needs to be reflected, either along the top-to-bottom if the screen is laid back or left-to-right if the screen is rotated and laid back. This can be achieved in several ways:
The computer's display driver can be set to reflect the displayed image. Unfortunately, most modern computers do not offer support for this. (The setting is not a standard Windows feature but may be available in OEM display control panels.)
A second screen can be added to the machine that displays its image inverted, typically offered for use in autocues.
The application can display its user interface mirrored.

In the case where the mirroring is done by the computer or by a screen, most operations of the system through typical input modalities like keyboards and mice will function normally. Use of eye gaze requires additional consideration; this is discussed later.

Where the application takes responsibility for mirroring its user interface:
The display outside the application will be inverted.
Keyboard and similar inputs within the application will work without special programming.
Mouse input will be inverted, so the application will need to override the system supplied support for mice. At a minimum it will need to invert reported coordinates along one axis. It is also likely that the application will need to take responsibility for displaying the mouse cursor and invocating mouse clicks. (There is a possibility that an application can invert the mouse reports before the level at which the cursor and click handling takes place, in which case the only further action may be to replace the standard mouse cursors with suitably inverted ones.)

Wherever the support for mirrored displays takes place, the styling of the user interface will normally need to be different. Specifically, the user interface may best be styled to be stokes of white and other light colors against a black background, blocks of solid colors are best avoided.

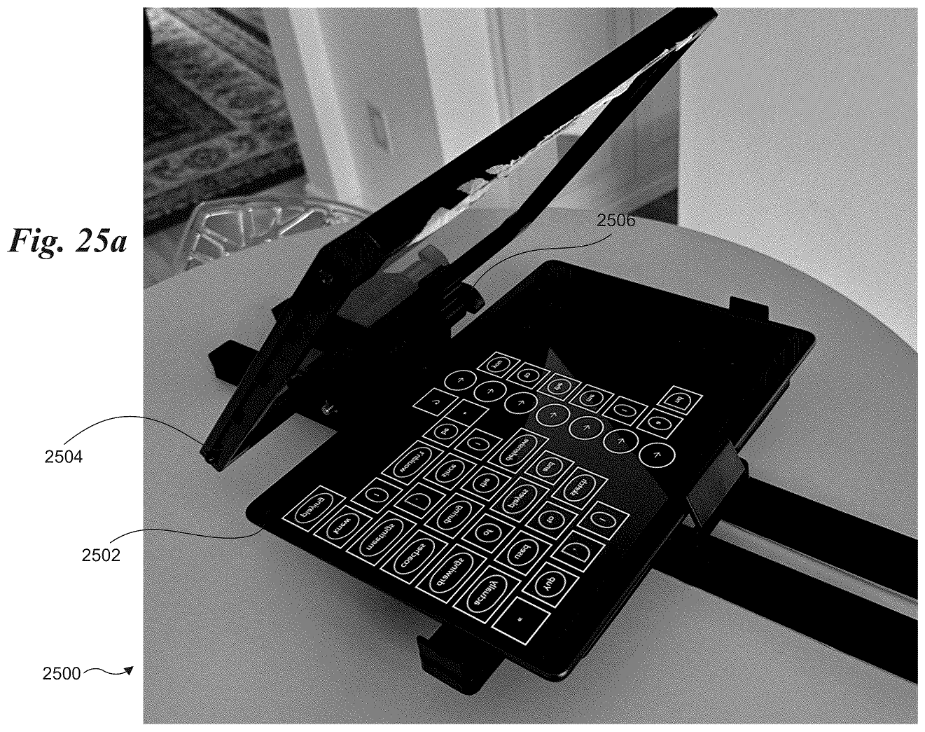

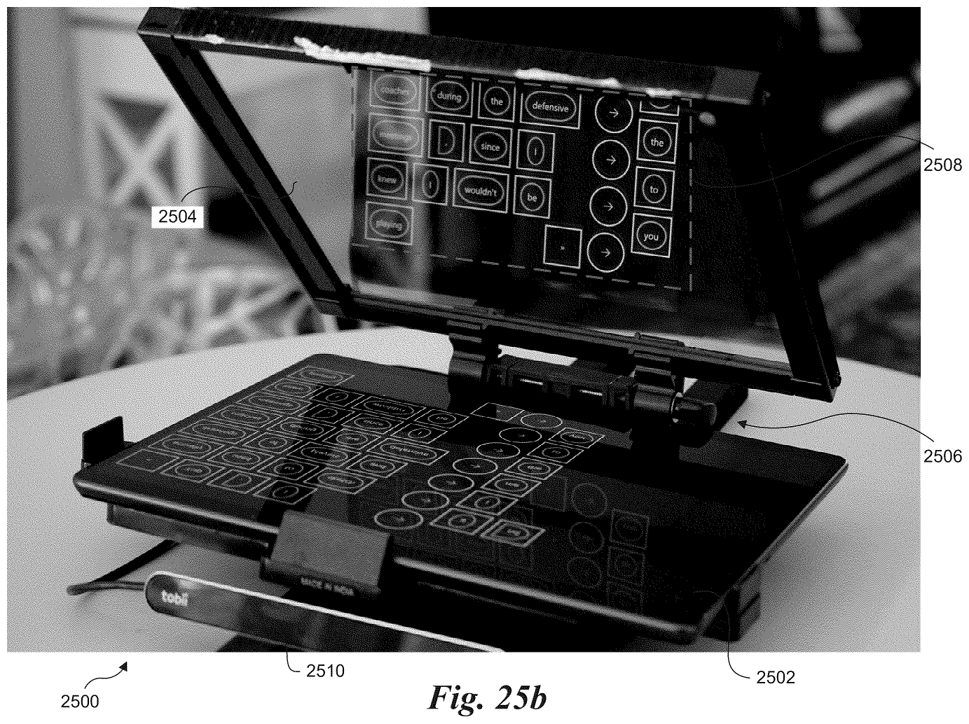

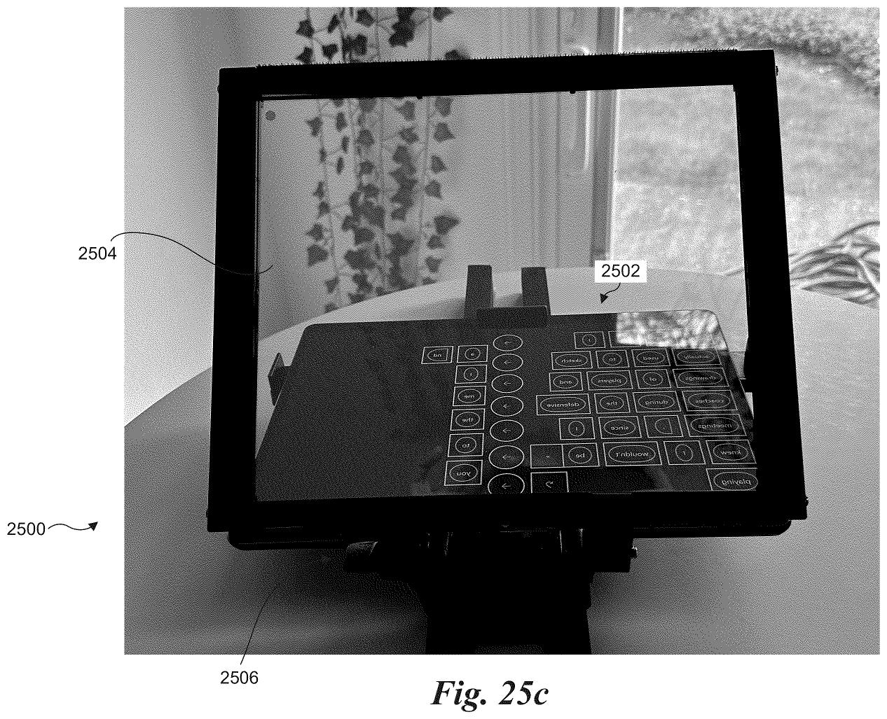

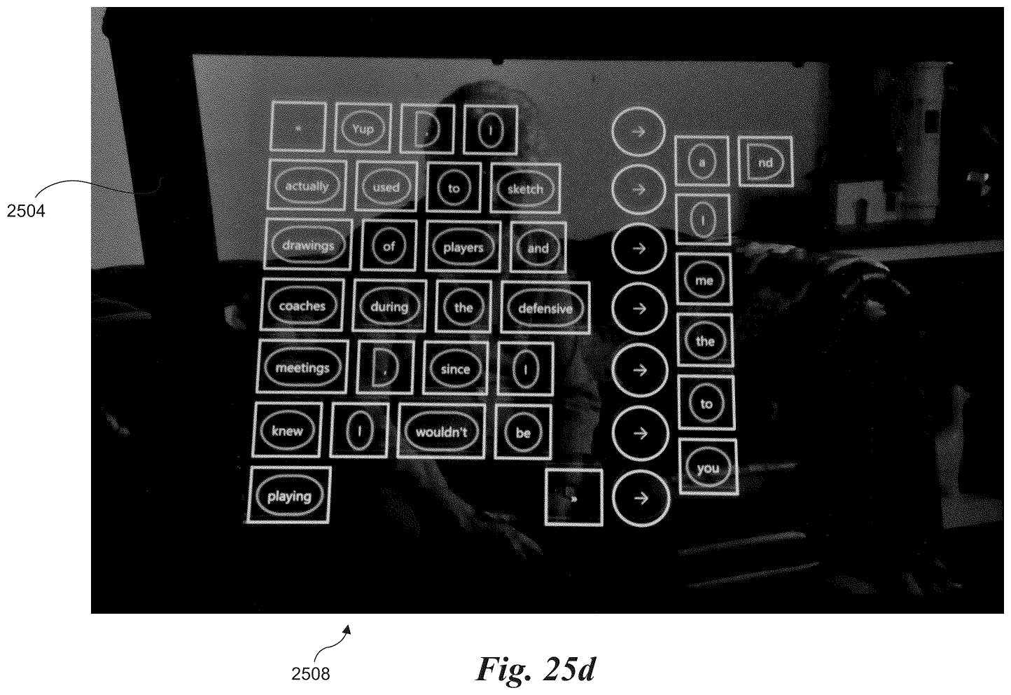

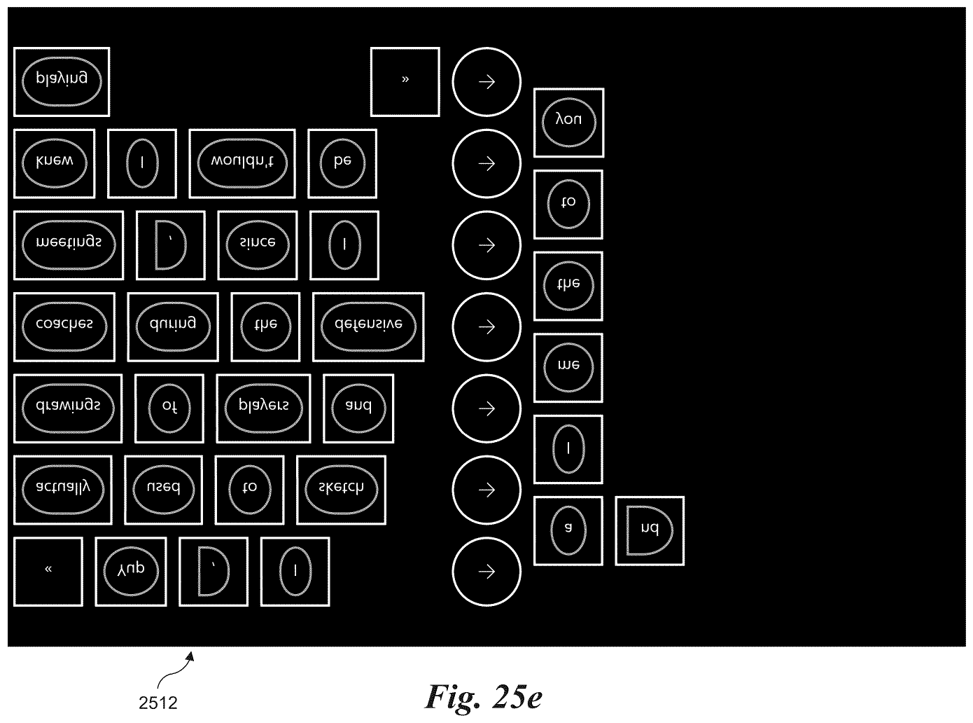

FIGS. 25a, 25b, and 25c show 3D views of an autocue 2500, according to one embodiment. Autocue 2500 includes a tablet 2502 that is disposed in the horizontal plane (in this example). An augmented user interface is displayed on tablet 2502 where the buttons and text are horizontally inverted. A reflector 2504 is operatively coupled to tablet 2502 via a hinge mechanism 2506. Reflector 2504 includes a half-silvered mirror or similar planar reflective surface disposed in a frame to which hinge mechanism 2506 is coupled. Hinge mechanism 2506 allows the user to adjust the angle of reflector 2504 relative to the display for tablet 2502 and then lock that angle in place. Hinge mechanism 2506 is also configured to enable autocue 2500 to be folded in a flat configuration.

In FIG. 25b a virtual image 2508 of the user interface is shown, along with an eye tracker 2510. Due to how light is reflected, the orientation of the user interface is correct in both the horizontal and vertical axes. As shown in FIG. 25c, for a person or people on the opposite side of the user, reflector 2504 is transparent, which enables the person or people to see the user and make eye contact with him or her.

FIG. 25d shows how virtual image 2508 appears from the viewpoint of a user. As further shown, the person the user is communicating with can be seen through reflector 2504, enabling the user to make eye contact with that person.

FIG. 25e shows a user interface 2512 rendered on tablet 2502 for the autocue implementation shown in FIGS. 25a-25d. As depicted, the elements in user interface 2512 are inverted vertically (along with the overall user interface). In one embodiment the user interface may be changed from a conventional orientation (e.g., tablet is orientated in landscape with the user interface not inverted) to an autocue orientation (such as shown in user interface 2512) through use of a configuration menu or softkey (not shown).

### Head Up Display and Eye Gaze

Most likely, eye trackers are unlikely to work efficiently if mounted to the bottom of the display screen being view via the autocue mirror. These devices use infrared light that is unlikely to be mirrored well and, if they do see the user's face, the inverted view may not play well with their programming.

The better solution is to mount the eye tracker at a location just below where the reflected image is seen by the user. This arrangement will work in a mount where the screen can be raised and lowered between vertical and horizontal positions along a pivot at the bottom of the screen.

In this arrangement, the eye tracker will be in its expected position when the screen is vertical. Thus, all the software that utilizes the eye tracker will function normally without modification.

When the screen is flat and being used through the autocue mirror several steps need to be taken:
A custom calibration mechanism needs to be used, since the systems that ship with the eye tracker will not perform the coordinate mirroring necessary. Most developer interfaces for eye trackers allow the application to tell the eye tracker where the targets the user is calibrating to are located, and these supplied coordinates can be mirrored by the application.
Because the eye tracker and display screen have an unusual relationship to one another, rather than the normal “tracker below the screen” relationship, calibration will be very specific to a single head location. For people living with ALS, maintaining a fixed head location after calibration is not the problem it could be with other users.

### Powered Screen Mount

Using the system in the traditional way of looking directly at the computer screen or tablet device is likely to provide a better machine interaction experience compared to using the via mirrored surface, though the reverse is likely true.

A powered mount that allows the screen or tablet to be swapped between conventional and head up display mode would function thus:
The screen or tablet device is mounted on a pivot that allows the display to be pivoted around its bottom edge between its vertical position facing towards the user and horizontal position facing upwards.
The mirrored glass is mounted so that when the screen is horizontal the display is visible to the user. The simplest mount for glass may allow for the glass to temporarily move out of the arc the display moves through as it transitions between horizontal and vertical positions; such mounted glass may rely on gravity or a spring to return to its working position when the display is not in the space normally occupied by the glass.
The mirrored glass can remain in its head up display position when not in used while the system is used in the conventional mode. More elaborate mechanical operations are possible, moving the glass to a more protected location.
When an eye tracker is being used, this will be mounted in a non-pivoted location below the visible image when the display is in both horizontal and vertical orientations.
The powered transition can be initiated by the computer using a motor or similar device when instructed by the user.
An alternative implementation would have the transition initiated by a carer; if such a manual transition is used the transition can be made manually by the carer without power supplied by a motor.

### Example Mobile Platforms

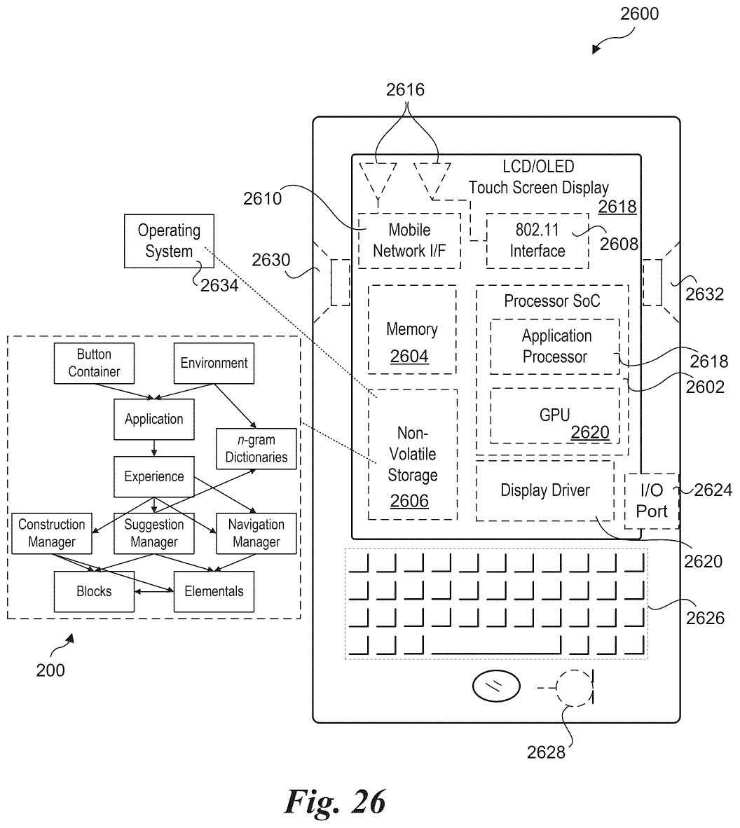

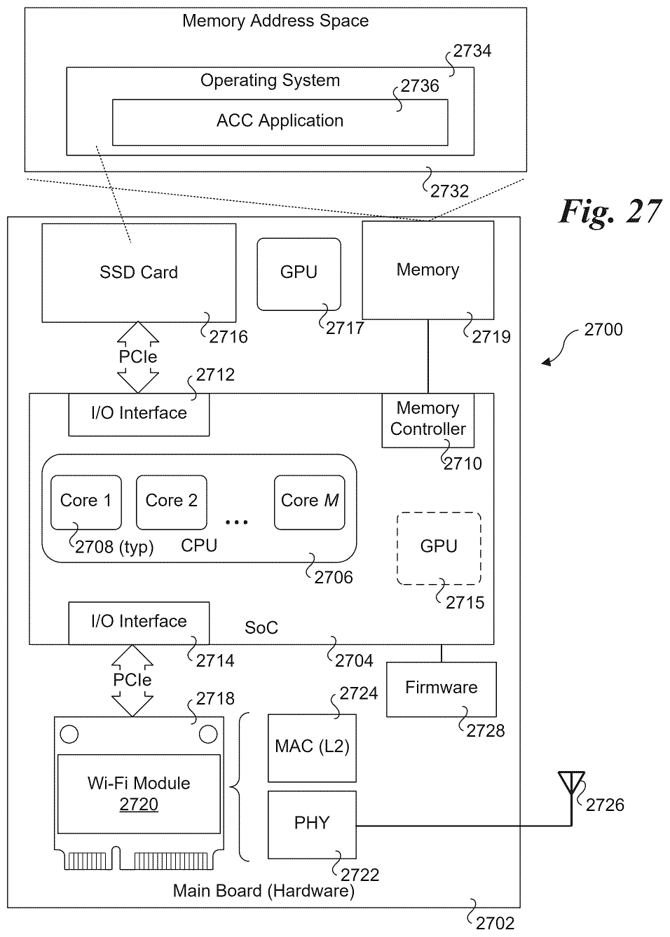

Examples of exemplary mobile platforms that may be used to implement aspects of the embodiments disclosed herein are shown in FIGS. 26 and 27. FIG. 26 shows a mobile device 2600 that includes additional software to support functionality in accordance with aspects of one or more of the embodiments described herein. Mobile device 2600 includes a processor SoC 2602 including an application processor 2618 and a GPU 2620. Processor SoC 2602 is operatively coupled to each of memory 2604, non-volatile storage 2606, an IEEE 802.11 (WIFI™) wireless interface 2608, and a mobile network interface 2610, each of the latter two of which is coupled to a respective antenna 2616. Mobile device 2600 also includes a display screen 2618 comprising a liquid crystal display (LCD) screen, or other type of display screen such as an organic light emitting diode (OLED) display. Display screen 2618 may be configured as a touch screen though use of capacitive, resistive, or another type of touch screen technology. Mobile device 2600 further includes a display driver 2620, an Input/Output (I/O) port 2624, a virtual or physical keyboard 2626, a microphone 2628, and a pair of speakers 2630 and 2632. In some embodiments I/O port 2624 comprises a USB-C port, although other types of existing and future I/O ports may be used.

During operation, software instructions and modules comprising an operating system 2634, and software modules for implementing an AAC application are loaded from non-volatile storage 2606 into memory 2604 for execution on an applicable processing element on processor SoC 2602. For example, these software components and modules, as well as other software instructions are stored in non-volatile storage 2606, which may comprise any type of non-volatile storage device, such as but not limited to Flash memory. In addition to software instructions, a portion of the instructions for facilitating various operations and functions herein may comprise firmware instructions that are stored in non-volatile storage 2606 or another non-volatile storage device (not shown).

In some embodiments, mobile device 2600 comprises a tablet format, such as but not limited to a MICROSOFT® SURFACE® device, an ANDROID® tablet, on an APPLE® IPAD®. In some embodiments when mobile device 2600 is a MICROSOFT® SURFACE® device, operating system 2634 comprises a MICROSOFT® WINDOWS™ operating system, such as WINDOWS™ 11 or a future version of a WINDOWS™ 11. In some embodiments when mobile device 2600 is an ANDROID® tablet, operating system 2634 operating system 2634 comprises an ANDROID® operating system 1100, such as ANDROID® 13 or 14 or a future version of an ANDROID® OS. Similarly, in some embodiments when mobile device 2600 is an APPLE® IPAD® operating system 2634 comprises iPadOS 17.x or a future version of iPadOS.

APPLE® recently announced that upcoming versions of iPadOS running on recently-released IPAD® Pro and IPAD® Air models (and possibly earlier IPAD® models) will have built-in support for eye tracking. Such IPAD® models could be used to run AAC applications using the conventional configuration of FIGS. 23a and 24 without requiring a separate eye tracker.

Non-limiting examples of computer platform or system architectures for a laptop or notebook computer are shown in FIG. 27. Under platform architecture 2700, the computer platform/system includes hardware 2702 comprising a main board to which a processor System on Chip (SoC) 2704 is mounted (e.g., via flip-chip bonding, socketed, or any other mounting technique). Processor SoC 2704 includes a central processing unit (CPU) 2706 having M processor cores 2708, where M is an integer such as 4, 6, 8, 10, 12, 14, 16 . . . etc. In this example, the processor cores are depicted as to appear the same for simplicity. An SoC may include more than one type of processor core, such as a combination of higher performance cores that consume relatively more power and lower performance cores that consume relatively less power. Generally, CPU 2706 may employ various types of architectures including but not limited to x86 architectures and ARM®-based cores, RISC, etc., including a mixture of core architectures. Processor SoC 2704 further includes a memory controller 2710 and a pair of I/O interfaces 2712 and 2714. In addition to the components shown, processor SoC 2704 would generally include a cache hierarchy and various levels of interconnects that are not shown for simplicity and to reduce clutter. For example, each processor core 2708 may include a Level 1 (L1) and Level 2 (L2) cache, while the SoC may include a Last Level Cache (LLC) that is shared among the processor cores.

In some embodiments processor SoC 2704 includes a Graphics Processor Unit (GPU) 2715, while in other embodiments a GPU 2717 that is external to the processor SoC is employed. A processor SoC may also include a myriad of other components, such as power-related components, and management components that are also not shown for simplicity and clarity.

Hardware 2702 further includes a solid-state disk (SSD) card 2716, a wireless card 2718, and memory 2719. SSD card employs a type of non-volatile memory, such as a type of Flash memory, NVRAM, etc. In one embodiment, SSD card is a mini-PCIe (Peripheral Component Interconnect Express) card or an M.2 card and is connected via a PCIe interconnect/bus to I/O interface 2712. Other interconnect structures and protocols may also be used, with the use of PCIe in the figures herein being merely exemplary and non-limiting.

Wireless card 2720 is depicted as a mini-PCIe card that includes a Wi-Fi module 2720 that includes suitable circuitry and logic for implementing one or more IEEE 802.11 standards. The circuitry and logic include circuitry for implementing a Physical Layer (PHY) 2722 and a Media Access Control Layer (MAC) 2724. The MAC layer is Layer 2 for both Wi-Fi and Ethernet-based network interfaces. PHY 2722 is connected to an antenna 2726. Wi-Fi module 2720 may also provide other types of wireless support, such as BLUETOOTH®.

Hardware 2702 also includes one or more firmware storage devices 2728, which is/are used to store platform firmware. Memory 2719 is physically implemented as one or more DRAM (Dynamic Random Access Memory) devices or modules, such as DRAM DIMMS (Dual Inline Memory Modules). Memory 2719 and memory controller 2710 comprise a memory subsystem that may be compatible with various memory technologies, such as DDR4 (Double Data Rate version 4, initial specification published in September 2012 by JEDEC (Joint Electronic Device Engineering Council). DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5), DDR6 (DDR version 6), LPDDR5, HBM2E, HBM3, and HBM-PIM, or others or combinations of memory technologies, and technologies based on derivatives or extensions of such specifications. The JEDEC standards are available at www.jedec.org.

The physical memory on the memory devices/modules are mapped into a memory address space 2732 into which software is loaded for execution. This includes an operating system 2734 and an AAC application 2736. Generally, the software loaded into memory address space 2732 may be stored on SSD card 2716 or loaded via a network once the platform has booted. The computer platform/system will also load system firmware into a protected region in memory address space 2732 to facilitate booting the platform and also to be used for run-time operations.

A power source (not depicted) provides power to the components of hardware 2702. The power source generally interfaces to one or multiple power supplies in the computer to provide power to the components of the computer platform. In one example, the power supply includes an AC to DC (alternating current to direct current) adapter to plug into a wall outlet. In one example, the power source can include an internal battery in combination with an alternating current supply.

Generally, other computer platforms and systems such as desktop computers and workstations, may employ similar architectures to that shown in FIG. 27. Some differences include a GPU may be installed on the main board or deployed in an expansion card or the like, such as but not limited to a PCIe expansion card. A desktop computer may also include a networking card or networking chip to provide a wired Ethernet connection to a local AP or switch. For example, non-limiting examples include a Network Interface Controller (NIC) chip or expansion card with a NIC. Generally, a desktop computer or workstation may or may not include provisions for wireless communication.

### Distributed Environments

As discussed above, under some embodiments external (to the local computing device, platform, etc.) resources are used to perform a portion of the workload/functionality, such as through use of a GPT/LLM Web service (e.g., ChatGPT).

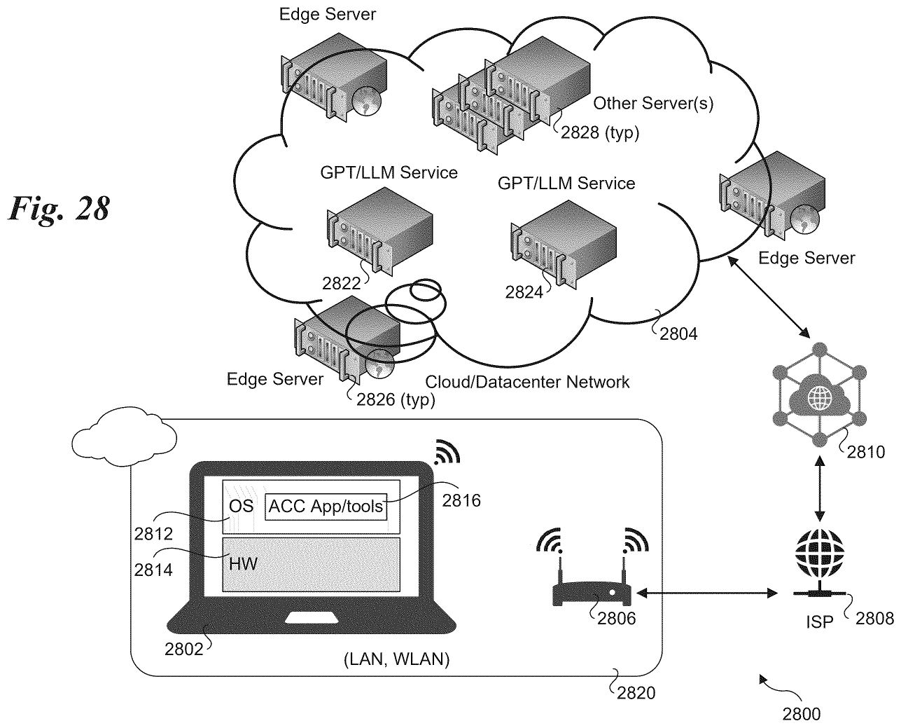

FIG. 28 shows an exemplary system architecture 2800 under which an AAC application may be implemented using distributed computing, according to one embodiment. The architecture components include a computer platform 2802 that is coupled to a cloud environment 2804 via applicable network facilities, which in this example include a wireless access point (AP) 2806, an ISP (Internet Service Provider) network 2808, and an Internet subnet 2810 which comprises a portion of the Internet.

Computer platform 2802, which is representative of various types of computer platforms and systems such as but not limited to laptops, notebooks, tablets, and desktop computers, includes an operating system 2812 and hardware (HW) 2814. In the illustrated embodiment, an AAC application and/or tools 2816 are run on OS 2812.

Wireless AP 2806 is used to provide communication to local computer platforms and devices in a LAN or WLAN comprising a network 2820. Meanwhile, cloud environment 2804 comprises a cloud or Datacenter network.

GPT/LLM services 2822 and 2824 are implemented in cloud environment 2804, which may also include one or more edge servers 2826 and one or more other servers 2828 as well as storage facilities, databases, data stores, and the like (not shown). In some environments, a GPT/LLM service may be implemented in an edge server.

Generally, cloud environment 2804 may comprise various forms of network-based environments. For example, cloud environment 2804 may be implemented through use of servers and the like provided with cloud-hosted services, such as AMAZON® Web Services (AWS®), MICROSOFT AZURE®, GOOGLE® Cloud, or a myriad of other cloud-hosted services. The cloud environment may employ an SASE architecture or provide other security measures at the cloud edge. The use of ‘cloud’ herein is used to convey these components are deployed in a network (or networks) remote from a user's local network. While many secure cloud environments are deployed in cloud providers, co-location or privately owned data centers and server farms and the like, the use of ‘cloud’ here is not limited to data centers and server farms. For example, a secure cloud environment may comprise an enterprise network that is deployed on premise, such in a company building or other private or dedicated facility.

GPT/LLM services 2822 and 2822 are illustrated of various types of GPT-like services that employ LLMs and are accessible to clients using one or more APIs (Application Program Interfaces). For example, GPT/LLM services 2822 and 2822 may deployed as Web services (e.g., microservices), or provide other means for servicing client requests. In this example, software running on platform 2802 would be the client. That client could be part of AAC accessible shell and called by the AAC application.

Under another cloud-hosted embodiment, the AAC application is implemented as a Web service using a Web browser. In this case, software for implementing the AAC accessible shell is hosted (run) on one or more servers, and the UI is generated using Web pages. The Web pages are rendered locally on a Web browser running on the user's device (local computing platform), and provide means for interacting with the Web service using known techniques.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘i’, ‘j’, ‘l’, ‘m’, ‘n’, ‘p’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core, or embedded logic, or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for facilitating generation of written or spoken text, comprising:
presenting a user interface (UI) comprising a plurality of buttons, including,
a set of suggestion buttons arranged in rows on a first side of the UI, each suggestion button displaying an associated whole or partial word or phrase, wherein first suggestion buttons in respective rows are ordered alphabetically;
a plurality of navigation buttons disposed adjacent to the first suggestion buttons in the respective rows;
in response to a user activation of a navigation button,
determining first and second suggestion buttons associated with the navigation button; and
generating and displaying an updated set of suggestion buttons, wherein the associated whole or partial word or phrase associated with each of the suggestion buttons in the updated set of suggestion button begins with a letter or character string that is the same or alphabetically after the whole or partial word or phrase associated with the first suggestion button and is the same or alphabetically before the whole or partial word or phrase associated with the second suggestion button.

2. The method of claim 1, wherein a portion of the navigation buttons are vertically interposed relative to the rows of suggestion buttons, with a top navigation button disposed above a first row of suggestion buttons and a bottom navigation button disposed below a last row of suggestion buttons.

3. The method of claim 1, further comprising:
in response to a user activation of a suggestion button, adding an instance of the suggestion button that is activated to a text entry area on the UI.

4. The method of claim 3, further comprising updating the set of suggestion buttons to a default set of suggestion buttons.

5. The method of claim 3, further comprising:
updating the set of suggestion buttons based, at least in part, on the suggestion button that is added to the text entry area.

6. The method of claim 5, further comprising:
enabling the user to add a string of text to the text entry area through user activations of buttons including activation of multiple suggestion buttons in combination with activation of one or more navigation buttons; and
in response to a last word or phrase that has been added to the string of text,
updating the set of suggestion buttons based on a current state of the string of text.

7. The method of claim 6, further comprising:
maintaining one or more n-gram dictionaries; and
selecting suggestion buttons in the updated set of suggestion buttons using the current state of the string of text in combination with an n-gram dictionary.

8. The method of claim 1, further comprising:
sending text content reflecting a current state of the string of text to a Web service implementing one or more Large Language Model (LLM)-based predictors;
receiving a set of suggestions from the Web service that were generated using at least one of the one or more LLM-based predictors; and
updating one or more suggestion buttons based, at least in part, on the set of suggestions that are received.

9. The method of claim 1, further comprising:
observing dwell times of a user's eye gaze as the user is gazing at buttons; and
adjusting one or more of a size of buttons and layout of buttons based on observation of the dwell times.

10. A non-transitory machine-readable media having instructions stored thereon configured to be executed on computing device to enable the computing device to perform operations comprising:
presenting a user interface (UI) comprising a plurality of buttons, including,
a set of suggestion buttons arranged in rows on a first side of the UI, each suggestion button displaying an associated whole or partial word or phrase, wherein
first suggestion buttons in respective rows are ordered alphabetically;
a plurality of navigation buttons disposed adjacent to the first suggestion buttons in the respective rows;
in response to a user activation of a navigation button,
determining first and second suggestion buttons associated with the navigation button; and
generating and displaying an updated set of suggestion buttons, wherein the associated whole or partial word or phrase associated with each of the suggestion buttons in the updated set of suggestion button begins with a letter or character string that is the same or alphabetically after the whole or partial word or phrase associated with the first suggestion button and is the same or alphabetically before the whole or partial word or phrase associated with the second suggestion button.

11. The non-transitory machine-readable media of claim 10, wherein a portion of the navigation buttons are vertically interposed relative to the rows of suggestion buttons, with a top navigation button disposed above a first row of suggestion buttons and a bottom navigation button disposed below a last row of suggestion buttons.

12. The non-transitory machine-readable media of claim 10, wherein execution of the instructions further enables the computing device to:
in response to a user activation of a suggestion button, add an instance of the suggestion button that is activated to a text entry area on the UI.

13. The non-transitory machine-readable media of claim 12, wherein execution of the instructions further enables the computing device to update the set of suggestion buttons to a default set of suggestion buttons.

14. The non-transitory machine-readable media of claim 12, wherein execution of the instructions further enables the computing device to update the set of suggestion buttons based, at least in part, on the suggestion button that is added to the text entry area.

15. The non-transitory machine-readable media of claim 14, wherein execution of the instructions further enables the computing device to:
enable the user to add a string of text to the text entry area through user activations of buttons including activation of multiple suggestion buttons in combination with activation of one or more navigation buttons; and
in response to a last word or phrase that has been added to the string of text,
update the set of suggestion buttons based on a current state of the string of text.

16. The non-transitory machine-readable media of claim 15, wherein execution of the instructions further enables the computing device to:
maintain one or more n-gram dictionaries; and
select suggestion buttons in the updated set of suggestion buttons using the current state of the string of text in combination with an n-gram dictionary.

17. The non-transitory machine-readable media of claim 10, wherein execution of the instructions further enables the computing device to:
send text content reflecting a current state of the string of text to a Web service implementing one or more Large Language Model (LLM)-based predictors;
receive a set of suggestions from the Web service that were generated using at least one of the one or more LLM-based predictors; and
update one or more suggestion buttons based, at least in part, on the set of suggestions that are received.

18. The non-transitory machine-readable media of claim 10, wherein execution of the instructions further enables the computing device to:
observe dwell times of a user's eye gaze as the user is gazing at buttons; and
adjust one or more of a size of buttons and layout of buttons based on observation of the dwell times.

19. A non-transitory machine-readable media having instructions and data stored thereon comprising a toolkit including one or more associated tools, libraries, and frameworks, the toolkit configured to be installed in or integrated with an integrated development environment to enable developers to build an application to be run on a computing device and present a user interface (UI) comprising a plurality of buttons, including,
a set of suggestion buttons arranged in rows on a first side of the UI, each suggestion button displaying an associated whole or partial word or phrase, wherein first suggestion buttons in respective rows are ordered alphabetically;
a plurality of navigation buttons disposed adjacent to the first suggestion buttons in the respective rows;
wherein the toolkit enables the application to,
in response to a user activation of a navigation button,
determine first and second suggestion buttons associated with the navigation button; and
generate and display an updated set of suggestion buttons, wherein the associated whole or partial word or phrase associated with each of the suggestion buttons in the updated set of suggestion button begins with a letter or character string that is the same or alphabetically after the whole or partial word or phrase associated with the first suggestion button and is the same or alphabetically before the whole or partial word or phrase associated with the second suggestion button.

20. The non-transitory machine-readable media of claim 19, wherein a portion of the navigation buttons are vertically interposed relative to the rows of suggestion buttons, with a top navigation button disposed above a first row of suggestion buttons and a bottom navigation button disposed below a last row of suggestion buttons.

21. The non-transitory machine-readable media of claim 19, wherein the toolkit further enables the application to:
in response to a user activation of a suggestion button, add an instance of the suggestion button that is activated to a text entry area on the UI.

22. The non-transitory machine-readable media of claim 21, wherein the toolkit further enables the application to update the set of suggestion buttons to a default set of suggestion buttons.

23. The non-transitory machine-readable media of claim 21, wherein the toolkit further enables the application to update the set of suggestion buttons based, at least in part, on the suggestion button that is added to the text entry area.

24. The non-transitory machine-readable media of claim 23, wherein the toolkit further enables the application to:
enable the user to add a string of text to the text entry area through user activations of buttons including activation of multiple suggestion buttons in combination with activation of one or more navigation buttons; and
in response to a last word or phrase that has been added to the string of text,
update the set of suggestion buttons based on a current state of the string of text.

25. The non-transitory machine-readable media of claim 24, wherein the toolkit further enables the application to:
maintain one or more n-gram dictionaries; and
select suggestion buttons in the updated set of suggestion buttons using the current state of the string of text in combination with an n-gram dictionary.

26. The non-transitory machine-readable media of claim 19, wherein the application further enables the computing device to:
send text content reflecting a current state of the string of text to a Web service implementing one or more Large Language Model (LLM)-based predictors;
receive a set of suggestions from the Web service that were generated using at least one of the one or more LLM-based predictors; and
update one or more suggestion buttons based, at least in part, on the set of suggestions that are received.

27. The non-transitory machine-readable media of claim 19, wherein the toolkit further enables the application to:
observe dwell times of a user's eye gaze as the user is gazing at buttons; and
adjust one or more of a size of buttons and layout of buttons based on observation of the dwell times.
